(19) United States
(12) Patent Application Publication
(10) Pub. No.: US 2018/0156189 A1
(43) Pub. Date: Jun. 7, 2018

(54) USE OF BUOYANCY TYPE POWER GENERATION METHOD

(71) Applicant: Tetuji KOHSAKA, Toyama (JP)

(72) Inventor: Tetuji KOHSAKA, Toyama (JP)

(21) Appl. No.: 15/568,467

(22) PCT Filed: Apr. 27, 2016
(86) PCT No.: PCT/JP2016/063135

§ 371 Date: Feb. 2, 2018

(30) Foreign Application Priority Data
Apr. 30, 2015 (JP) 2015-092607

(51) Int. Cl. F03B 17/02; F04B 9/105; B64D 27/24; B60M 7/00; B66F 3/24; A01K 61/10; E04H 9/02; B60K 8/00; B64C 25/00; B62D 61/12; B01D 1/14; B01D 5/00; C02F 1/10

(52) U.S. Cl. CPC F03B 17/025; B64D 2027/026; B64D 27/24; B60M 7/003; B66F 3/24; A01K 61/10; E04H 9/028; B60K 8/00; B64C 25/001; B62D 61/12; B01D 1/14; B01D 5/006; C02F 1/10; F05B 2220/706; F04B 9/105

(57) ABSTRACT

To improve and use a “buoyancy type power generation method”. A method for harnessing buoyancy and a device therefor are described as prior art in Patent No. JP 5789231 B2 “Buoyancy Type Power Generation Method”. The present invention, adds “self-supply of driving power” as a new feature to the prior art. That is, the present invention is “a self-contained power generation method and a device therefor, for driving itself by means of power produced by itself and for generating power that can be used industrially”. Presented are: a “gap operation type float” and a “rotary type float” which have simple operating methods and configurations as novel power generation devices of the present invention; various devices such as a self-reliant electric-power plant, a bubble injection water maker, a wired electric aircraft, and a seismic isolator as utilization inventions that use the power generation device of the present invention; and various uses of the power generation device of the present invention, for the respective industrial fields.

### TECHNICAL FIELD

The present invention relates to “a self-contained power generation method and a device therefor, for driving itself by means of power produced by itself and for generating power that can be used industrially”, which is improved invention of the prior art in Patent No. JP 5789231 B2 “Buoyancy Type Power Generation Method”, and also relates to utilization invention to which the prior art and the improved invention are adapted.

### BACKGROUND ART

Usage of buoyant force as power is unprecedented.

### PRIOR ART DOCUMENTS

### Patent Documents

Patent documents 1: Patent No. JP 5789231 B2

### DISCLOSURE OF THE INVENTION

(Subject 1) “A Self-Contained Power Generation Method and a Device Therefor” which Enable “Self-Supply of Driving Power”

Invention of “a self-contained power generation method and a device therefor” is set as a subject in the present invention, which enables “to drive itself by means of power produced itself”, i.e., “self-supply of driving power”.

The “device therefor” is a “power generation device”, and the “power generation device” by its name may involve a “dynamo” in the present invention.

The feature of the prior art is that “the power generated by the power generation device is larger than the power for driving the power generation device itself”, and a “relation of generated power>driving power” is realized in it.

Therefore, the prior art has possibility of “invention” of “the self-contained power generation method and the device therefor, for driving itself by means of power produced by itself and for generating power that can be used industrially” which is to drive the power generation device with a part of the power generated by the power generation device using the “relation of generated power>driving power”. However, the “invention” is not described in the prior art.

(The Perpetual Motion Machine Problem)

The “self-contained power generation method and the device therefor” is concerned with the perpetual motion machine problem. A patent application which is interpreted as one for the perpetual motion machine is not accepted to be a patent object. For this reason, the above “invention” was not described in the prior art in order to avoid the situation that the perpetual motion machine problem serves as the reason for refusal.

Whereas, the prior art have been patented, and then, the conditions for embodying the possibility of the above “invention” are fulfilled.

(Subject 2) Power Generating Devices Simply Structured and Efficient: A “Gap Operation Type Float” and a “Rotary Type Float”

In the present invention, as novel power generation method and device therefor aiming to simplify the configurations of the prior art and to make more efficient, invention of a “gap operation type float” using an “interception of liquid pressure” and a “rotary type float” using an “imbalance of liquid pressure” is set as a subject.

The “gap operation type float” uses a very simple drive method of opening and closing of an “orifice”.

The “rotary type float” is a float making rotational motion by itself, and no device converting up-and-down motion to rotational motion is necessary.

(Subject 3) Utilization Invention Applying the Prior Art or the Present Improved Invention

Invention of various kinds of device such as an electric-power plant, overhead wire, an electric aircraft, a water making machine, etc. applying the prior art or the power generation device of the present improved invention is set as a subject.

### MEANS FOR SOLVING SUBJECT

(Subject 1) The “Self-Contained Power Generation Method and Device Therefor” which Enable “Self-Supply of Driving Power”:

Utility Value of Buoyancy

Although the gravity of the earth attracts objects toward the center of the earth, the pressure in fluid acts in all the directions. The buoyancy can be defined as “the upward force by the fluid which acts on the bottom of the object in the fluid in the gravitational field”. Therefore, it is possible to convert and use the downward force caused by the gravity to upward force, by using the buoyancy phenomenon occurring in the combination of the fluid and the object.

A float catches upward direction pressure.

The prior art and the present invention, are of devices which catch upward direction pressure among the pressure acting in all the directions in the fluid and convert the pressure to power, and the float is a tool for catching the upward direction pressure.

Why Big Power is Obtained Using Small Driving Power . . . “Relation of Generated Power>Driving Power”

An underwater float goes up by buoyancy. A power larger than the buoyancy is necessary to depress the float which went up. This means that to use the upward power of buoyancy as power is completely meaningless.

However, in the prior art, the driving power for leading the float to an up-and-down motion is small compared to the power yielded by the float moving up-and-down.

This is unreasonable at first glance.

Why the “relation of generated power>driving power” is realized (FIG. 2): “Minimum fluid” and “square cube law”:

1 the “Minimum Fluid”

The realization of the “relation of generated power>driving power” is explained by “minimum fluid”, namely, by a method reducing the amount of the operating fluid, as much as possible.

When a float is moved upward or downward by increasing or decreasing the level of the liquid holding the float, required driving power decreases more and more according to decrease of the amount of the liquid handled. When a float and a liquid are stored in a container, even if the liquid wrapping the float is few, the buoyancy occurs as Archimedes' principle and the float (27) can support the load (28).

However, under the float, space for the float to move up and down is required. By removing the liquid (30) which exists in the gap between the float bottom and the container bottom as much as possible in addition to making the gap (29) between the side surface of the float and the side surface inside of the container as narrow as possible, the float can descend by the draining (34) of few amount of liquid, and the float can go up by the pouring (33) of few amount of liquid. Thus, the “relation of generated power>driving power” can be realized by reducing the amount of liquid to be handled as much as possible (the minimum fluid).

Bellows-in-Gap:

For removing the liquid existing in the gap of the float bottom and the container bottom, bellows (31) are prepared in the gap.

The bellows expand and contract following the upward and downward movement of the float. Usual type bellows (16) in liquid contracts in response to the downward liquid pressure (18) on the bellows upper surface (17) (19). Then, bellows of unified form is used, which is made by vertically connecting parts of a rhombus shape (21) having a “valley” (20) as deep as possible, are used. The downward liquid pressure (23), acting on the “mountain” (22), is mostly offset with the upward liquid pressure (24). While the “mountain” is going to contract, the “valley” is going to extend, because the upward liquid pressure (24) and the downward liquid pressure (25) act on the “valley”. Contraction of the “mountain” and extension of the “valley” are balanced, and the bellows hold the original shape of them mostly.

The upper part of bellows is connected to the float bottom with a space, and the bottom of bellows is fixed to the inside bottom of the container. The whole air inside the bellows is communicating with the open air, and is discharged and inhaled according to the contraction and extension of the whole bellows (32). Although there is a method making the bellows into a sealing state, the extension-contraction rate of the bellows is inferior.

Compound Bellows

Furthermore, for the purpose of removing more liquid, the “compound bellows” (26) is effective, which have enlarged total volume of the bellows by arranging a plurality of bellows by the method of engaging the “valley” and the “mountain”.

2 “Square Cube Law”

The “relation of generated power>driving power” is explained with a “square cube law”.

The cube (35) is expanded to similar figures.

If one side doubles, surface area will be 4 times as the 2nd power, and volume will be 8 times (36) as the 3rd power.

If one side increases 3 times, surface area will be 9 times as the 2nd power, and volume will be 27 times (37) as the 3rd power.

The surface area expands by the square and the volume expands by the 3rd power. This is the “square cube law”.

An “increase-decrease method of fluid specific gravity” is explained with the “square cube law”.

In the “increase-decrease method of fluid specific gravity”, air is injected to the float bottom sunk in the liquid, the bottom is covered with liquid mass of small specific gravity containing bubbles, or the float bottom is intercepted to contact with the liquid by the film of air, and then the float moves downward.

It is supposed that there is a cubical float and bubbles are injected to the bottom of the float.

When the float of this cube is expanded to similar figures, in it expanding process, the area of the bottom which is a area for injection increases by the square and thus the driving power increases by the square; the volume of the float increases by the 3rd power and thus the generated buoyancy increases by the 3rd power; and then the rate of increase of the buoyancy generated in the float is far larger than the rate of increase of the driving power used for injection. Therefore, if the float is large-sized and becomes larger and larger, bigger buoyancy will be acquired with relatively small driving power.

Example . . . A float of cube, whose whole is sunk in water.

When one side is 1 meter, the bottom area is 1 square meter and the volume is 1 cubic meter and the buoyancy is 1 ton.

When one side is 100 meters, the bottom area is 10,000 square meters and the volume is 1 million cubic meter and the buoyancy is 1 million ton.

The ratio of the bottom area to the volume namely buoyancy is expanded to 1:100 from 1:1.

This means that the ratio of the driving power to generated buoyancy is expanded to 1:100 from 1:1, and the “relation of generated power>driving power” is certainly realized in the process of expansion.

When a cubic float of one side 100 meters is used, the injection area of the float bottom measures 10,000 square meters, generated buoyancy is 1 million tons, and it is easy to inject air uniformly in the area about a baseball field using a part of electric power generated using the 1 million tons of buoyancy.

Use of the natural law, namely, “square cube law” shows that the “relation of generated power>driving power” is realized.

The Perpetual Motion Machine Problem

The prior art is a method and a device therefor, which “converts” an “input” of the “pressure of the liquid” to an “output” of the “kinetic energy of the float” according to the energy conservation law. The “driving power” is not the “input” but absolutely a driving power for the “conversion”. That is, the power which drives the float never changes to the “output”. There, A reasonable relation is realized between the “input”, the “output”, and the “driving power” for converting the “input” to the “output”.

If an oil stove is taken, for example, the “input” is the chemical energy of kerosene, the “output” is the thermal energy, and the “driving power” is a power for ignition and oil supply.

Therefore, if the perpetual motion machine is defined as a “device which works forever without adding energy from the exterior” (a perpetual motion machine of the first kind), the prior art does not correspond to the perpetual motion machine.

The “input” in the prior art is the “pressure of liquid” supplied inexhaustibly without cost by the action of the gravity of the earth.

Article 2 of Japanese Patent Law

Moreover, the present invention configured by improving the prior art, namely, “self-contained power generation method and a device therefor for driving itself by means of power produced by itself and for generating power usable industrially”, converts the “pressure of the liquid” as input to the “kinetic energy of the float” as output based on the reasonable relation and using the “relation of generated power>driving power”. Therefore, the present invention is not in violation of Article 2 of Japanese Patent Law “‘Invention’ in this law means the highly advanced creation of technical ideas utilizing the laws of nature”.

The Method of Self-Supply of Driving Power

A method how to drive the “power generation device” using a part of the power generated by the “power generation device”.

The “power generation device” by its name may involve a “dynamo” in the present invention, (0004).

When Electric Power is Used (FIG. 1)

1 The power generation device (2) generates the power (7).

2 The dynamo (8) is driven by the power and generates electrical power.

3 The part (10) of the generated electric power (9) is transformed and rectified with the device (11) which controls the driving power, and supplied to the power generation device (12).

4 Or the electric power is charged (13) in the battery (14) and supplied to the power generation device (15).

When Mechanical Power is Used

1 The power generation device generates power.

2 A part of the generated power is transferred mechanically to the driving mechanism of the power generation device.

The driving mechanism . . . Mechanism such as “opening and closing of an orifice” or “opening and closing of a valve” may be used. The pressure of a liquid may be used for transferring the power.

Generated power (electric power)—Power used for driving the power generation device (electric power)=usable power (electric power).

Selection of Driving Power

Although main driving power is the power generated by the power generation device of the present invention, the existing power network system may be used. When the power generation device is connected to the system, it is meaningless to distinguish the electric power self-made and the electric power from the conventional electricity generator.

The value of the present invention is in the fact that the driving is based on the “relation of generated power>driving power”, and thus, it is good to select one suitable from various sources of power.

Source of Power

A part of the power generated by the “power generation device”, a part of the electric power generated using the power generated by the “power generation device”, power supplied from a power generation device separate from the “buoyancy type power generation device”, electric power received from a power network system with which the “buoyancy type power generation device” cooperates, running water, and human power, etc.

The power generation methods of the prior art and the present invention, are unified by “liquid pressure operation method”.

In the present invention, the “interception of liquid pressure” and the “imbalance of liquid pressure” are newly used as the power generation method. The present invention is an improved invention, and in order to explain the power generation methods of the prior art and the present invention in a unified way, the power generation methods of both are involved in the “liquid pressure operation method”.
The prior art: 1 “increase-decrease of liquid level”
   2 “increase-decrease of generated buoyancy”
The present invention: 3 “interception of liquid pressure”
   4 “imbalance of liquid pressure”.

1 “Increase-Decrease of Liquid Level”

When a float is floated on a liquid and the liquid level is increased by pouring (33) the liquid, the float moves upward, and when the liquid level is decreased by draining (34) the liquid, the float moves downward.

When the liquid level is increased by pouring the liquid, the liquid pressure upward acting on the float bottom increases, and the float moves upward. That is, the float moves upward following the rise of the liquid level. Therefore, the “increase and decrease of liquid level” is an operation of liquid pressure.

2 “Increase-Decrease of Generated Buoyancy” . . . “Increase-Decrease of Fluid Specific Gravity” and “Increase-Decrease of Float Volume”

The “Increase-Decrease of Fluid Specific Gravity” (FIG. 3)

When the liquid specific gravity is decreased by injecting the bubbles (40) into the liquid (39 (sic)) on which the float (38) is floating, the buoyancy decreases and the float moves downward (41). If the bubbles are discharged, the buoyancy is recovered and the float moves upward.

That is, if the specific gravity of the liquid (fluid) is increased or decreased, the liquid pressure acting on the float bottom upward increases or decreases, and the float moves upward or downward.

The method intercepting the contact between the float and the liquid with the film made of the injected air is also involved in that.

“Increase-Decrease of Float Volume”

When the volume of the float floating on the liquid is increased or decreased without changing the weight of the float, the liquid pressure acting on the float bottom upward increases or decreases, and the float moves upward or downward to balance the weight and the buoyancy of the float.

3 “Interception of Liquid Pressure”

When the liquid pressure (47) acting upward on the bottom of the float (46) floating on the liquid (45) is intercepted (48), the buoyancy extinguishes, and the float moves downward. If the interception is cleared the buoyancy is recovered, and the float moves upward. Refer to the “gap operation type float” (0027 (sic)).

4 “Imbalance of Liquid Pressure”

The “rotary type float” (57 (sic)), of which density is equal to that of the liquid, is immersed in the liquid, and bubbles (44) are injected onto the right-hand side (42) of the float bottom with injection device (43). By the same principle as the above 2 “increase-decrease of fluid specific gravity” (0023 (sic)), the liquid pressure acting upward on the right-hand side of the float bottom decreases, and weight arises on the right-hand side.

That is, if the liquid pressure, acting on either right-hand side or the left-hand side of the “rotary type float” bottom, is made imbalance by decreasing or intercepting the pressure, the buoyancy decreases at the portion undergoing the reduction or interception, weight arises, torque is generated, and the float rotates. Refer to the “rotary type float” (0033 (sic)).

The Classification of the Operation Method on the Basis of the Operation Object (“Fluid” and “Float”)

“Fluid operation” . . . Both of the above 1 “increase-decrease of liquid level” and the above 2 “increase-decrease of fluid specific gravity” operate liquid or gas, and they are classified as the “fluid operation”.

“Float operation” . . . The above 2 “increase-decrease of float volume” operates the float, and it is classified as the “float operation”.

(Subject 2) The Power Generation Device Simply Structured and Efficient: The “Gap Operation Type Float” and the “Rotary Type Float”

The “gap operation type float” (FIG. 4)

“Interception of Liquid Pressure”

The “gap operation type float” of the present invention uses the interception of the liquid pressure conduction to the float bottom, i.e., the “interception of liquid pressure”. The float loses the buoyancy and moves downward by intercepting (48) the liquid pressure conduction (47) to the float bottom (46) in the liquid (45), and the float recovers the buoyancy and moves upward by clearing the interception. The feature of the “gap operation type float” is that the float itself is equipped with a mechanism which carries out the “interception of liquid pressure” intermittently.

Constituent Elements

The float upper part (49) . . . Generating the buoyancy in response to the liquid pressure at the bottom.

The float lower part (50) . . . Having the gap (51) filled with the liquid, and expanding and contracting according to the bellows structure (52) or the cylinder structure (54) and (55) equipped with the sealing mechanism (53), and making the float upper part move upward and downward.

The orifice (56) . . . A device for driving the “gap operation type float”, prepared at the float lower part, capable of opening and closing. By opening, the liquid pressure is channeled into the gap, and by closing, the channeling of the liquid pressure is intercepted.

The bellows-in-gap (57) . . . Prepared in the gap in order to reduce the amount of liquid in the gap. It expands and contracts in phase with the upward and downward movement of the float upper part. The container is not necessarily used.

There is also a method of using a “liquid reservoir” other than the method using the “bellows-in-gap”.

The liquid reservoir . . . Prepared by connecting to the float lower part. Absorbing the liquid from the gap when the float moves downward, pushing and moving the liquid into the gap when the float moves upward.

The liquid reservoir and the bellows-in-gap may be used together.

Gap Operation

By closing the orifice, the liquid pressure conduction into the gap is intercepted, and the “float upper part” cannot receive the upward liquid pressure, lose the buoyancy, and moves downward. At this time, the “float lower part” and the “bellows-in-gap” contract simultaneously. Although the volume of the “gap” decreases during the downward moving, the amount of liquid in the gap does not change because the “bellows-in-gap” contracts.

By opening the orifice, the liquid pressure is conducted into the gap, and in response to the upward liquid pressure, the “float upper part” recovers buoyancy and moves upward. At this time, the “float lower part” and the “bellows-in-gap” expand simultaneously.

When the “bellows-in-gap” expands or contracts, the air is absorbed into the bellows or the air is exhausted from the bellows (58).

Thus, the float is moved upward and downward, by intercepting the liquid pressure conduction into the gap intermittently by opening and closing the orifice, and such a float is the “gap operation type float”.

Liquid Reservoir

The “liquid reservoir” is a device which stores the liquid in the gap intermittently using instruments able to increase and decrease the volume, such as bellows and a cylinder etc. When the gap contracts, the liquid moves from the gap to the liquid reservoir, and when the gap expands, the liquid moves from the liquid reservoir to the gap.

Liquid Reservoir Pressing-Out Power Heading to the Gap

When the gap expands, a power for sucking the liquid into the gap from outside of the gap works through the orifice. It is necessary to make the pressing-out power to the gap from the liquid reservoir larger than the sucking power from the orifice into the gap, in order to move the liquid from the liquid reservoir into the gap during the upward movement of the float. For the pressing-out power, various methods are considered such as using the climbing power of the float, however a method of moving the liquid in the gap mutually between two combined sets of the gap operation type float has simple composition, and is efficient.

The necessary power for opening and closing the orifice and for pressing out the liquid in the liquid reservoir is small, and the “relation of generated power>driving power” is realized satisfactorily.

“Rotary Type Float” (FIG. 5)

The prior art drives a dynamo by converting the up-and-down motion of the float to rotational motion. By the way, if the float can be rotated, the device for converting the up-and-down motion to the rotational motion is omissible.

“Imbalance of Liquid Pressure”

The “imbalance of liquid pressure” is used as the method for leading the rotary type float to continuous rotation. The “rotary type float” (50 (sic)) is a float doing a vertical rotation around a level rotation axis (60) and a cylinder shape is the most efficient. Here, the principle is explained using a cylindrical rotary type float. In addition, the part to which the operation is made is expressed by the clock position (61).

If the inside of the float (62) of cylinder shape which rotates vertically is divided vertically into two by a partition and water is poured into the right-hand side (63), the right-hand side becomes heavy, torque arises, and it rotates (64) clockwise around the rotation axis. However, the torque disappears and the float comes to rest at a state where the weight of right and left is balanced (65). (When water is poured into the left-hand side, it rotates counterclockwise)

Three Kinds of Methods of Making Torque Continue . . . “Imbalance Immersion”, “Liquid Pressure Interception Operation”, and “Liquid Pressure Reduction Operation”

The condition to make the rotary type float rotate continuously is to make the torque generation continue. By imbalancing the upward forces acting on right-hand side and left-hand side of the float immersed in the liquid, the weight of right-hand side and left-hand side is made imbalance, the torque is generated, and the float is led to rotational motion.

In order to make the state of “imbalance of the liquid pressure” continue, in the improved present invention, the above-mentioned condition is fulfilled by the three kinds of methods: the “imbalance immersion”, the “liquid pressure interception operation”, and the “liquid pressure reduction operation”.

“Imbalance Immersion”

If the rotary type float is filled (66) with water in the whole inside of it, put in the container (67) which is prepared for imbalance immersion, and then if the float is immersed (68) with only the left-hand side of the float in the water, the weight of the left-hand side is lost by the buoyancy (69), on the other hand, in the right-hand side which is not immersed in the water, and thus the torque (71) is generated with the weight (70) of the float itself. The float rotates clockwise by the torque, and the torque in the right-hand side does not disappear, because the left-hand side is immersed and the right-hand side is not immersed, and this state is kept. Therefore, the float continues rotation, without coming to rest. (When making the right-hand side immersed, the rotation becomes counterclockwise)

“Liquid Pressure Interception Operation” . . . Gas Interception

The rotary type float is filled with water inside, and the float is put in the water. Both the inside and outside of the float are water, and the whole float is in the state of no weight, by the buoyancy. By injecting air continuously to the lower part periphery on the right-hand side of the float (clock position 3:00 to 6:00 (61)), the contact of the lower part periphery and the water is intercepted with the layer of flowing air. The right-hand side of the float loses buoyancy, weight is generated, torque is generated, and the float continues rotation clockwise. (When injecting on the left-hand side, the rotation becomes counterclockwise)

“Liquid Pressure Interception Operation” . . . Object Interception

The interception is done by sticking an object, in place of the “gas interception”. By pressing an arc-shaped object (similar to 43) which can be stuck to the float periphery against the lower part periphery on the right-hand side of the float (clock position 3:00 to 6:00 (61)), the contact of the lower part of the periphery and the liquid is intercepted. In order to reduce the friction between the lower part periphery and the object, the liquid is good to use oil or the like. The right-hand side of the float loses buoyancy, weight is generated, torque is generated, and the float continues rotation clockwise. (When injecting (sic) on the left-hand side, the rotation becomes counterclockwise)

“Liquid Pressure Reduction Operation”

The rotary type float is filled with water inside, and the float is put in the water. Both the inside and outside of the float are water, and the whole float is in the state of no weight, by the buoyancy. By injecting bubbles (44) continuously to the lower part periphery on the right-hand side of the float (clock position 3:00 to 6:00 (61)), the lower part periphery is covered with liquid mass of small specific gravity (density) containing bubbles. Buoyancy decreases in the right-hand side of the float, weight is generated, torque is generated, and the float continues rotation clockwise. (When injecting on the left-hand side, the rotation becomes counterclockwise)

Density of the Rotary Type Float and the Torque Generated

The inside of the float is filled with water (liquid) in order to make the specific gravity (density) of the float and that of the water (liquid) wrapping the float be equal. The float may be made using a solid material sufficiently. The density of the rotary type float is good to make it the same as that of the density of the liquid to be used. If it is smaller than the density of the liquid, torque decrease. Conversely, if it is larger, only the torque corresponding to the density of the liquid is obtained. It is because only the buoyancy, corresponding to the density of the liquid, is generated.

Example: If the density of the float is 2 and the density of the liquid is 1, the generated buoyancy is 1.

If the left-hand side of the float is immersed in the liquid, the left-hand side becomes light due to only the part of buoyancy, and weight is set to 2−1=1. The right-hand side is still 2. The ratio of the weight of the left-hand side and the right-hand side is set to 1:2, and the right-hand side becomes heavy only 1. That is, the torque generated is set to 1.

In the “liquid pressure interception operation” and the “liquid pressure reduction operation”, the “relation of generated power>driving power” is satisfactorily realized by the “square cube rule” (0013 (sic)).

Although driving power is not needed for the “imbalance immersion”, friction of the sealing mechanism in the measure against leakage of water becomes a disincentive factor for the rotation. However, friction is of “surface” and “square cube law” carries out appropriate also here. The float is so advantageous that it is large.

Injection Device Used for “Liquid Pressure Interception Operation” and “Liquid Pressure Reduction Operation”

In the case of bubble injection, the density of the liquid decreases uniformly according to the bubbles being small and numerous. If the bubbles are too big, the liquid pressure reduction effect is hardly produced, because the low density air and the high-density liquids are mixed unevenly and the liquid contacts the float by pushing away the bubbles. The form of the injection device having an arc form covering the cylindrical periphery is efficient.

Combined Use of “Liquid Pressure Interception Operation” and “Liquid Pressure Reduction Operation”

It is effective to carry out the “liquid pressure interception operation” in the liquid mass containing bubbles by covering the float with the liquid mass containing bubbles using the “liquid pressure reduction operation”.

The Adjustment Method of an Output

“Liquid Pressure Interception Operation” . . . Increasing and Decreasing of the “Injection Area”.

“Liquid pressure reduction operation” . . . Increasing and decreasing of the “injection area”. Increasing and decreasing of the injection amount of the bubbles. Adjusting of the distance of the float surface and the injection device.

“Imbalance immersion” . . . Increasing and decreasing of the immersed area of the float bottom. Carrying out of the above-mentioned method of the “liquid pressure interception operation” and the above-mentioned method of the “liquid pressure reduction operation” for the immersed area.

Unification of the “Rotary Type Float” and the Dynamo

The rotary type float can be used as a dynamo by preparing a permanent magnet group or an electromagnet on the cylinder periphery, and preparing a coil group in the circumference of them.

An “up-and-down motion dynamo” using the up-and-down motion of a float

If a coil and a permanent magnet are brought close to each other or moved away from each other electric current will arise by electromagnetic induction. Although it is the very primitive power generation method, it becomes possible to generate electricity using the up-and-down motion of the float as it is.

Configuration

A permanent magnet or an electromagnet is attached to the float upper part, and a coil is fixed and installed at a suitable distance kept from the float upper part. Or a coil is attached to the float upper part, and a permanent magnet or an electromagnet is fixed and installed at a suitable distance kept from the float upper part. If the float is moved up and down, current will arise in the coil by the electromagnetic induction.

The following is details of utilization invention, using the power generation device of the present invention.

“Jack”

A jack which makes a heavy load go up and down by buoyancy, which uses a “liquid level increase-decrease method”. Buoyancy is generated even if the gaps of the container inner side wall and the float side wall are very small. The float is stored in the container, and the float loaded with the heavy load is made to move upward by pouring liquid into the container, or made to move downward by draining the liquid from the container.

Configuration

Float, liquid, container, guide rail, and device for pouring and draining the liquid.

A very large-sized jack can be made. Moreover, each parts can be disassembled and conveyed, and a movable jack can be realized by the method pouring water on site.

A “Pump”, a “Press Pump”

It is the combination of the power generation device of the present invention, and conventional “pump” and “press pump”. It is driven mechanically by the rotational motion or the up-and-down motion of the float generated by the “power generation device”, or driven by the electric power generated by the “power generation device”. The valve operation method differs between the “pump” and the “press pump”.

Configuration

The power generation device of the present invention, conventional rotary pump—press pump and conventional reciprocation pump—press pump.

Buoyancy Type “Pump—Press Pump”

This is the buoyancy type pump made by adding the component of the pump to the power generation device of the present invention. A piston can be driven by the up-and-down motion of the float, or the upper part of the float can be used as a piston. The upper part of the piston is stored in a cylinder, and fluid is inhaled and evacuated by the up-and-down motion of the piston and operation of the valve. In the case of a press pump, the fluid is evacuated after the compressing of the fluid.

Configuration

The power generation device of the present invention featuring in the reciprocating motion, a cylinder storing the float as a piston, a valve, and a valve operation device.

It can be characterized by low rotation large capacity, and very large-sized pump, which is impossible with the conventional pump, can be manufactured.

Electricity Generation Facility and Electricity Transmission Facility Relating to the Electricity Power Supply Using the Power Generation Device of the Present Invention

Electricity Generation Facility

Self-Reliant Type Electricity Generation Facility

It is a electricity generation facility installed in a fixed place, using the power generation device of the present invention, and when a scale is large, it is considered as an electric-power plant. The independency that it does not need energy supply from the exterior is the feature.

Movable Self-Reliant Type Electricity Generation Facility

It is a electricity generation facility using the power generation device of the present invention, and movable by being mounted on a carrying means. It can be mounted on a vessel and an aircraft (especially rotary-wing type) besides an electric power supply car using a car or a railroad vehicle.

Electricity Transmission Facility—Electric Power Supply Device

“Fixed Type Wire” and “Floated Type Wire” (FIG. 6)

The “fixed type wire” (73 (sic)) . . . A supported overhead wire, for the purpose of supplying electric power to the “wired aircraft” or an electric aircraft, supported with the wire pillars (74 (sic)) etc. installed on the ground or buildings.

The electric power supply (75 (sic)) . . . The power generation device of the present invention, the power network to which the power generation device of the present invention is connected by power system interconnection, the “fixed type wire” (electric power can be supplied to the fixed type wire from the fixed type wire.)

The “floated type wire” (76 (sic)) . . . A supported overhead wire, for the purpose of supplying electric power to the “wired aircraft”, supported by the “wire support aircraft (77 (sic))” and installed floating in air.

The electric power supply (75 (sic)) . . . The power generation device of the present invention, the power network to which the power generation device of the present invention is connected by power system interconnection, the “fixed type wire”.

A “direct-current electricity supply device” which supplies electric power, generated with the power generation facility, to direct current driven electric appliances with matched voltage for the electrical appliances.

Diversity of Electric Power Supply

The electric power supply can also use the power network to which the electricity generator of the present invention is connected by power system interconnection, besides the power generation device of the present invention. When the electric power generated by the electricity generator of the present invention is connected by power system interconnection, it is completely impossible to classify the electric power by the present invention and the electric power by the existing power generator.

The “Wire Support Aircraft” (77 (Sic))

It is a aircraft for the purpose of supporting the wire by flying in a fixed position in air at rest when the “floated type wire” is laid in air.

Features

Flying with the electric power collected or received from the wire;

flying with rotary wing;

laying wire in air;

supporting the wire in a rest state in air; and

mending the fractured wire.

Laying Work of the “Floated Type Wire” by the “Wire Support Aircraft”

The “wire support aircraft” holds the wire connected to the electric power supply, takes off while collecting the electricity from the wire, and carries the wire in air.

One by one, many “wire support aircraft” pursue the same work.

If the wire is carried to the target position, the wire is supported there by the planes in that position at rest.

“Wired Aircraft” . . . “Moving Type” and “Fixed-Position Type”

It is a manned or unmanned electric aircraft which flies with the electric power collected or received from the wire. There are “moving type” and “fixed-position type” according to a flight form.

The “Moving Type Wired Aircraft (78 (Sic)) (79 (Sic))”

It is an electric aircraft for the purpose of carrying a person, thing, information, etc., by flying with the electric power collected using an electricity collecting device (pantograph) from the “fixed type wire” or the “floated type wire”. When the collecting device is parted from the wire or in a zone where no wire is laid, it flies with a battery etc.

The “Collecting Device” Used for the “Moving Type Wired Aircraft”

As the collecting device, there are a “fixed collecting device” installed on the main body of the “moving type wired aircraft” and a “electricity collecting drone” connected with a cable to the “moving type wired aircraft”, which collects the electricity contacting the wire while flying and sends the power to the main body, namely, the “moving type wired aircraft”.

The “Fixed Collecting Device” (80 (Sic))

It is similar to the pantograph installed on the conventional train, trolley bus, etc.

The “Electricity Collecting Drone” (81 (Sic))

It is an unmanned electricity collecting aircraft for the purpose of supplying a power to the “wired aircraft” via a cable by collecting the electric power from the “fixed type wire” or the “floated type wire” while flying.

Features

Connected with a cable to the main body of the “wired aircraft”;

capable to detect and contact the “fixed type wire” or the “floated type wire” and keep the contact state;

capable of making contact again immediately when the wire is parted; and

the electric power supply based on the electricity collection from the “fixed type wire” or the “floated type wire”, or the electric supply from the main body of the “wired aircraft”.

The “Fixed-Position Type Wired Aircraft” (82 (Sic))

It is an electric aircraft doing various work, flying in a fixed position in air at rest, while receiving the electric power from the “floated type wire” by hanging the “floated type wire (76 (sic))”, or collecting the electric power by using the collecting device (81 (sic)). When the “floated type wire” is huge, the “wire support aircraft” (77 (sic)) is used in order to cope with the wind pressure.

Application of the “Fixed-Position Type Wired Aircraft”

“Takeoff-and-Landing Auxiliary Aircraft”

It is a “fixed-position type wired aircraft” for the purpose of making the aircraft, that features the horizontal-takeoff-and-landing, takeoff or land vertically. At the place in which an airfield cannot be set, the aircraft for horizontal-takeoff-and-landing can be made to take-off and to land. If it is a place where the electric power supply can be prepared, its operation is possible wherever in the mountain or on the ship.

In order to carry a large-sized aircraft safely in air, big electric power is needed, but it is possible as long as the electric power is received from the wire. Even if it becomes the situation of stopping in air under a certain situation for a long time, depletion of electric power does not occur.

Features

Landing Assistance

It catches and holds the aircraft which is going to landing, in air while flying, and carries the aircraft to the landing point while descending.

Takeoff Assistance

At the takeoff point, it holds the aircraft which is going to taking off, goes up, and releases the aircraft in the takeoff position to make the aircraft fly.

Communication business aircraft (radio wave tower, base station, relay station, etc.) . . . It is a “fixed-position type wired aircraft” which stays at a fixed position in air, and performs communication-related affair.

Aircraft for forestry . . . It is a “fixed-position type wired aircraft” which performs forestry-related work such as tree felling, conveyance of trees, etc., while flying over a predetermined area of forest.

Various examples of use for fire fighting, for construction, etc. can be considered besides the “taking-off-and-landing auxiliary aircraft”, the “communication business aircraft”, and the “aircraft for forestry”.

High Temperature Bubble Injection Type Water Maker (FIG. 7)

The amount of evaporation of liquid is determined by the added quantity of heat. The purpose of the pressure reducing device (ejector) of multi-stage flash system is to make the boiling point low, and the decompression operation does not necessarily increase the amount of evaporation.

The purpose of the “water maker” of the present invention is to reduce sharply the cost of the device and the running cost of water making, by using the low cost energy and simplifying the structure specializing in heat boil.

Hot air changed to bubbles is injected into the raw water such as sea water.

The raw water (84) is put into the container (83), air is heated to high temperature with the “heating device (85) based on press pump”, and the air is changed to the bubbles with the injection machine (86) and injected (84) into the raw water in the container. For heating of the air, an electric heater may be used together. When the heated raw water boils (88), the injected bubbles containing water vapor, fill the inside of the container. The vapor-containing air in the container is pushed out (89), with the hot air injected in, out of the container, moves to the condenser (90), and the distilled water (91) is made.

Configuration

Container, raw water, compressor of the present invention, injection machine, condenser, the pouring and draining device (92) (93) of raw water

Injection machine . . . The finer bubbles are more efficient, because the contact surface between the air and the raw water becomes larger with the finer air bubble.

Simple condenser . . . A radiator system is simple for the condenser. The hot air containing a lot of vapor is introduced into a pipe and cooled with sea water or air from a blower.

Heating method of air . . . It is simple to use the “press pump” of the present invention with a high compression ratio. An electric heater may be used.

Hanging Type Seismic Isolator Using Buoyancy (FIG. 8)

The power generation device of the present invention using the float has a problem of being vulnerable in an earthquake. So a seismic isolator using buoyancy is used as a measure.

The structure (95), in which the power generation device is placed, and the liquid (96) are contained in the container (94), and hung with the column support (97) for hanging. Elastic bodies, such as a spring, are used for the hanging device (98). Usually, the structure is fixed with the fixing device (99), and the fixing is released when the preliminary tremor has been sensed.

Although the fixing device (99) has a portion fixing the side of the structure, and a portion supporting the bottom of that, the method, using an elastic body for the “portion supporting the bottom” and always fixing, may be sufficient. In this case, only the fixing of the side is released at the time of the occurrence of an earthquake.

Since the structure does not have weight in the state floating on the liquid (acceleration due to gravity does not act), there is no load for the hanging. In the occurrence of an earthquake, the column support shakes together with the surrounding ground, but in order that the structure may try to stop at the original position according to inertia, the shake of up-and-down and right-and-left is reduced.

Although the weight of the structure changes and the structure rises and falls in connection with entrance and exit of person or thing into the structure, it is good to carry out the pouring and draining of the liquid into/from the structure for the purpose of adjusting the weight.

If bubbles are injected into the water at the side of the structure, at the time of the occurrence of an earthquake, the liquid mass containing bubbles will serve as a cushion and the quake-absorbing effect will increase moreover.

It is affected by the influence of a wind when installing in the outdoors. The circumference of the seismic isolator may be covered with a wind protection cover aiming at protection against wind, or a wind protection board may be formed on the column support.

Configuration

Structure as a float containing the power generation device, liquid, container or excavated hole for containing the structure and liquid, column support, hanging device, fixing device The seismic isolator can be applied to the ground, which supports a building or a building group, and can be used as a quake-absorbing building.

Use for Mining and Manufacturing

In all the fields of mining and industry, big electric power cost reduction becomes possible by using the power generation device of the present invention.

Use . . . Chemicals manufacture, aluminum refinement, iron manufacture by an electric furnace, carbon fiber manufacture, others.

Synthetic Oil Made from Air and Water as Materials

Hydrocarbon is compounded by using as materials the carbon dioxide collected out of the atmosphere and the hydrogen obtained by the electrolytic process of water. The cost of materials will be zero if a production facility is installed in the place where water is obtained.

Marine-Resources Development

The power generation device of the present invention is not dependent on the atmosphere. Therefore, it is very useful to resources development to the inside of the sea, and the seabed.

Use . . . The submarine boat for seabed-resources development, a sea factory, submarine factory

Utilization in Agriculture

By use of the prior art or the power generation device of the present invention, all the arable land, the lights, the water, and temperature, which are agricultural conditions, can be made artificially, and it can be operated. That is, it is agricultural industrialization.

Use

Arable land . . . Irrigation Desert tree planting Plant factory

Water . . . Water making by the water maker

Light . . . Artificial light

Temperature . . . Air-conditioning machine

The 3-Dimensional Light Source Using the Power Generation Device of the Present Invention

As for light, illuminating at right angles to a leaf is most efficient. By making the light source 3-dimensional, not planar, and by making the illuminating not only vertical but also horizontal with the artificial light, whole of a plant can be mostly wrapped in light. Cube lattice-like arrangement etc. are effective.

Use to a Fishing

The power generation device of the present invention is used for the fishing implements and each process such as discovery for capture, movement for location, capture, conveyance, etc. Farmland is developed by irrigation. The fishing grounds can be expanded or stabilized by preparing the conditions for raising fishes. “Industry” character is added to fishing as well as agriculture.

Use

A fishing boat, a diving fishing boat, aeration device, various finders and sensors, a fish preserve, a marine ranch.

Underwater Capture by a Submergible Fishing Boat

As for the conventional fishing method, a captor (fisherman) does the capture work of fishes at sea (onboard). However, if the power generation device of the present invention independent of the atmosphere is used, the conventional fishing boat can be used as a submarine boat, and capture work can be done in the inside of the sea or lake.

The artificial fish reef using the power generation device of the present invention

By supplying the artificial fish reef, which uses the power generation device of the present invention, with oxygen, a mineral, and light, it becomes possible to enrich seaweed, plankton, etc. which are base of the food chain, to raise a marine product, and to capture fishes alive after selection.

A Building, a City, and a Life Environment

The power generation device of the present invention is used as a private electricity generator of a building. It also becomes possible to install a building and a building group in a hydrospace or on a sea bed.

Use . . . An underwater building, a sea bed building, a warehouse performing low cost control of inactive gas filling, temperature, and humidity, a data center, and aeration device aiming at an environmental clean-up.

Means of Transportation

By using the power generation device of the present invention, all conventional type transportation means can be electrified. Run in water is also attained according to the feature independent of the atmosphere.

Use . . . Car, electric train, ship and vessel, submarine boat, aircraft, transit system using the wired aircraft, snow melting system of track and road

In the case of a flying boat, which can fly by oneself equipped with the electricity generator of the present invention, the following features can be given.

At the time of water-landing of the flying boat, bubbles are injected into the water area of water-landing, so that the shock at the time of water-landing is weakened. The injection of the bubbles is done using an injection machine installed in airport or an injection machine with which the flying boat is equipped.

The transit system using the wired aircraft uses the “fixed type wire” or the “floated type wire”, and the wired aircraft carries the loads from a shipping source to a shipping destination. Or, the loads are carried to a relay place, put together for each delivery direction at the relay place and sent to a relay place of a shipping destination, and individualized for each delivery address at the relay place of the shipping destination and delivered to each of the shipping destinations.

The snow melting system sprays water, which is heated by passing a pipe equipped with an insulated electrical heater wire. Or, an air jet is emitted through the pipe heated.

A Hydrofoil Train Using the Power Generation Device of the Present Invention

It is a electric train equipped with a waterway in rail track, and runs with a lift force obtained by inserting the hydrofoils in the waterway.

Offset of the Car Weight by the Lift Force

When the running starts, the lift force is generated in the hydrofoils inserted in the waterway, and the weight of the car body is offset by the lift force.

The car body, in which the weight is decreased or disappeared, is made to run using drive wheels.

Electric Power Supply

The electric power may be collected from the wire, when a conventional rail truck is remodeled and used. When a new rail truck is constructed and used, the wire laying becomes unnecessary by mounting the electricity generator of the present invention on the car body.

An Inclined Waterway

When the waterway is inclined, water may be made to flow from the summit portion of the waterway and made to be running water.

A tandem car equipped with the power generation device of the present invention (FIG. 9)

It is a two-wheel passenger car with auxiliary wheels, which can run without any energy supply from the outside by reducing the load to the electricity generator by making the car body small.

Features:

Two (or three) run wheels are arranged in series (101) (100);

a plurality of seats are arranged in series (102);

auxiliary wheels (103) (104) are in the right and left of the car body for the purpose of the prevention from overturning; and

the engine (105) is driven in combination with the electricity generator of the present invention and a battery, or in combination with a conventional type engine and the electricity generator of the present invention.

The following features can also be added.

An accelerator is a manual type and a conventional accelerator pedal operated on foot is not used;

the accelerator operation is done by setting the speed arbitrarily by manual operation and the car body runs at the set-up speed.

A brake should be a manual type, a foot brake type of conventional brake pedal, or a combination of the manual type and the foot brake type.

The brake operation is done by reducing the set-up speed or recovering the set-up speed by releasing the brake operation, through the operation of the manual type or the foot brake type.

Electrical appliances using the power generation device of the present invention By installing the electricity generator of the present invention into various electrical appliances, it becomes possible to use by cordless specification. Or, by micro-miniaturizing the electricity generator of the present invention, it becomes possible to connect with a portable telephone, a personal computer, etc., and to use by indefinite duration specification without battery duration problem.

### Effect of the Invention

The method for motorizing buoyancy and its device are indicated in the prior art, namely, the U.S. Pat. No. 5,789,231 “buoyancy type power generation method”. The novelty of the present invention is an addition of the “self-supply of driving power” as a feature to the “buoyancy type power generation method”. That is, the present invention is “self-contained power generation method for driving itself by means of power produced by itself and for generating power that can be used industrially, and a device therefor”. The fact that the present invention does not correspond to the perpetual motion machine is explained in the specification.

The problems of the conventional type electricity generator are enumerated. Nuclear power generation . . . Radioactive waste of difficult disposal, wide range contamination in case of an accident, and difficulty of output control.

Thermal power generation . . . Exhaustion of resources, smoke, carbon dioxide, and other wastes

Water-power generation . . . Environmental destruction, expensive construction cost, and difficulty of output control.

Photovoltaics . . . High cost and dependency on natural conditions.

Wind power generation . . . Environmental destruction, noise, and dependency on natural conditions.

As for the power generation device of the present invention, all the above-mentioned problems are solved.

The “gap operation type float” and the “rotary type float” are newly proposed by the present invention. The simplicity of the operation and the structure is conspicuous. The use as a private electricity generator has a big possibility.

“Cable Type Aircraft”

The running cost of the “moving type wired aircraft” sharply decreases by the low cost electric power. However, dramatic cost reduction of construction expense is conspicuous moreover. When constructing a railroad or a road newly, in addition to the expense of development, immense expense for land acquisition poses a problem. Negotiation takes great time and work because of complicated right relation involved. However, the present invention only floats two wires in air, and is completely unrelated to the above-mentioned problems. Predominance is clear if the linear Shinkansen full of tunnels and the present invention flying calmly over mountains is compared.

“Transit System”

Although integration transportation is efficient, it requires manpower and time.

Although individual transportation is high cost very much, speedy delivering is possible.

If the defect of the individual transportation is dissolved by using low cost electric power and unmanned transportation, the revolution will occur in logistics. An ideal is the high-speed delivery and low fee uniformly across the country by the individual transportation, and it may serve as a trigger device for district activation. If the handicap in logistics is resolved, there will be no demerit in realizing a production base in local region. The distributed production bases are unified organically and they function as though one factory.

“High Temperature Bubble Injection Type Water Maker”

Although the water making system of the Middle East oil producing countries is of very large-scale, this is dependent on the fossil fuel of low cost. In the area not blessed with the fuel resources, to realize it is hard. In the water making using the present invention, the production cost and the water supply cost are very low, and the larger the making scale the more efficient because of the “square cube rule”. Although water flows from high to low, the “water” goes up from sea-level zero meter to inland and to mountain land with the water maker of the present invention and a pump. The low cost energy induces the low cost water, and a lot of low cost water raises agricultural products.

Although the 20th century is of the oil scramble, it is said that the 21st century will be of the fresh water scramble. The water maker of the present invention will call off the scramble involving water, and will adjust the inevitability of the history.

“Hanging Type Seismic Isolator Using Buoyancy”

The quake-absorbing method using buoyancy as anti-earthquake measures of a building is already put in practical use (partial float). The seismic isolator of the present invention aims to absorb the quake of the “power generation device”, and is characterized by the canceling of the weight of an object (float), of which quake is absorbed, by buoyancy, and also characterized by the hanging using the column support. However, by expanding the use range of the device to a building or a building group, it becomes very contributory to disaster prevention. If it expresses figuratively, a building will be a ship and the hanging device will be an anchor. Because the weight of the building is canceled, there is no load for hanging, and probably it may be possible to make the wide range ground itself quake-absorbing.

“Tandem Passenger Car”

It is conceived as a car which combines the amenity of a passenger car and a light heart of a motorcycle. An electric vehicle has few parts and can be used by maintenance-free mostly. Although the demerit of the electric vehicle is the expensive battery, the battery can be made into small capacity by securing a suitable output. Although it is a car of dream for which a gas station and also a charge stand are unnecessary, It is realizable.

Since the accidents caused by stepping on the brake and the accelerator by mistake occurs frequently, it should be avoided to arrange the accelerator pedal and the brake pedal for stepping in parallel. In the present invention, the accelerator specializes in constant speed setting by manual operation, and the speed is decreased or increased within the setting speed by braking operation. When driving at a slow speed, what is necessary is just to set to about the same speed as a walk by manual accelerator operation, and to carry out slowdown or acceleration suitably by the brake pedal. An accident, rushing into a convenience store caused by mistake in stepping on a pedal, could be prevented at least.

### BRIEF DESCRIPTION OF THE DRAWINGS

FIG. 1 is a conceptual diagram of the “self-contained power generation method and the device therefor” which enables “self-supply of driving power”, where electric power is used for driving power.

FIG. 2 is a conceptual diagram for explaining “minimum fluid” and “square cube law” as the grounds for why the “relation of generated power>driving power” is realized. Especially about the bellows used for the method of the “minimum fluid” is illustrated in detail. The device numbered 27 to 34 are conceptual diagrams of a device which makes the float move upward and downward by pouring and draining the liquid using a “liquid level increase-decrease method” and the “bellows-in-gap”.

FIG. 3 is a conceptual diagram illustrating a “fluid specific gravity increase-decrease method” and a “liquid pressure interception method”. It shows a method for injecting bubbles into a liquid for floating a float moving up-and-down and a float rotating.

FIG. 4 is a conceptual diagram of the “gap operation type float”. It shows an explanatory diagram of the “liquid pressure interception method” and the structure of the “gap operation type float” of expanding-contracting type and penetrating type”.

FIG. 5 is a conceptual diagram of the “rotary type float”. It contains an explanatory diagram of the “liquid pressure imbalance method” and an explanatory diagram of a device using the “imbalance immersion”.

FIG. 6 is a conceptual diagram of the “fixed type wire”, the “floated type wire”, the “moving type wired aircraft”, and the “fixed-position type wired aircraft”.

FIG. 7 is a conceptual diagram of the “high temperature bubble injection type water maker”.

FIG. 8 is a conceptual diagram of “hanging type seismic isolator using buoyancy”.

FIG. 9 is a conceptual diagram of the “tandem car equipped with the power generation device of the present invention”.

### MODE FOR CARRYING OUT THE INVENTION

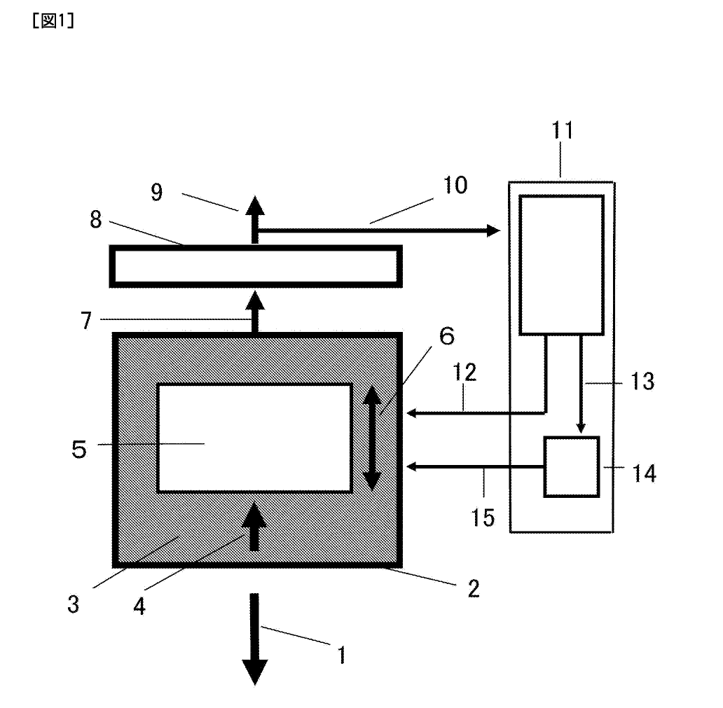

Hereafter, the embodiments of the present invention are explained based on FIG. 1-FIG. 9.

“Self-Supply of Driving Power”

FIG. 1 is a conceptual diagram of the method for performing “self-supply of driving power” using electric power.

Gravity 1 is the downward force toward the center of the earth. In the power generation device 2, the liquid 3 and the float 5 are contained, and in the liquid 3 subjected to the action of the gravity 1, the pressure works in all directions. Since the pressure acts perpendicularly to the object surface, it acts as an upward force 4 at the bottom of the float 5. This is the buoyancy.

To start up the power generation device 2, electric power 15 of the battery 14 is used. The float 5 having the buoyancy is led to the up-and-down motion 6 by the “liquid pressure operation method” (0021), and the power 7 is generated. The dynamo 8 is driven by the power 7 to generate electricity, and a part of the generated electric power 9 is adjusted to electric power suitable for a drive, by a device (transformer, rectifier, charger, start, stop, or the like) 11 for controlling the driving power. The power generation device 2 is driven by the transformed and rectified electric power 12, or by the electric power 15 charged in the battery 14.

Driving power is not necessarily self-sufficient. The purpose is to be able to obtain an amount of power that exceeds the input driving power and still allows industrial use, and for this purpose, various power sources should be prepared and selected appropriately. The “driving power control device” that selects and controls the driving power is described in claim 2.

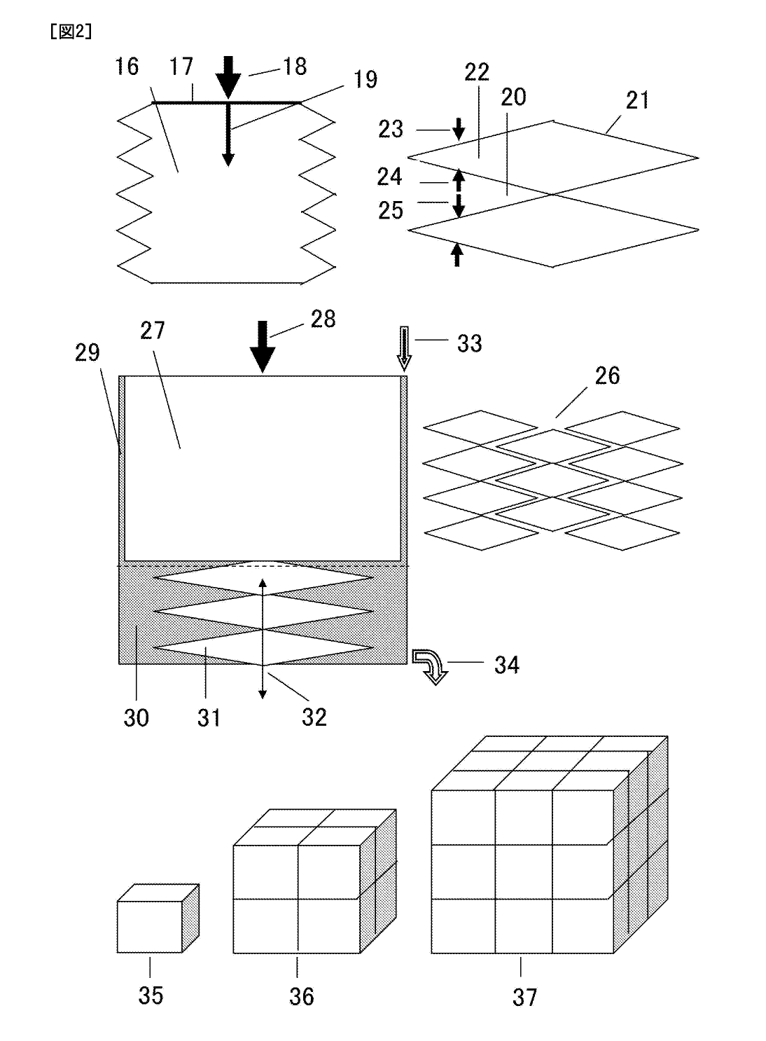

Power generation device using “liquid level increase-decrease method” FIG. 2 is an explanatory diagram of “minimum fluid” and “square-cube law” which are grounds for realization of the “relation of generated power>driving power”, and a conceptual diagram of the power generation device using the “liquid level increase-decrease method” based on the principle of the “minimum fluid”, and an explanation on the “bellows-in-gap” is shown.

When a “device; i.e., a float stored in a container” is installed along a river and the running water of the river is poured in the container, the float will go up. When the pouring is stopped and the water is drained from the container, the float will descend. Although it is very simple structure, power generated. This depends, as an energy source, on natural running water, and belongs to renewable energy. However, with this composition, a big merit cannot necessarily be referred to, when compared with turbine type running water power generation.

The power generation device using the “power generation method” is configured to generate the power by an operation of the liquid as little as possible, i.e., the “minimum fluid”, as an ideal, and to realize the “relation of generated power>driving power”. The device for reducing the fluid is the “bellows-in-gap” 31 (0013).

In claim 4, the power generation device using the “liquid level increase-decrease method” is indicated. Since the liquid in the container is reduced by the “bellows-in-gap” 31, the liquid level is increased or decreased by slightly increasing or decreasing the amount of liquid. As a method of increasing or decreasing the liquid level, in addition to a circulation method in which liquid is injected 33, discharged 34, and the discharged liquid is injected again, a method, in which the liquid amount is increased or decreased in a pseudo manner, namely, an object is inserted into or removed from the liquid, is also effective. If “composite bellows” 26 is used, the amount of liquid is further reduced and the efficiency becomes high.

In claim 5, an electricity generator using running water is described. The electricity generator has one side of renewable energy. As in claim 4, the required amount of water has been drastically reduced, the float goes downward by the slight water draining 34, and the float goes upward by the slight water pouring 33. Even when the running water is depleted, the electricity generator can be driven by the circulation of water remaining in the container. Therefore, it does not depend on natural conditions, there are no constraints on installation place and operation time. The movement of the float up and down is regulated by a guide rail.

“Fluid Specific Gravity Increase-Decrease Method” and “Liquid Pressure Reduction Operation”

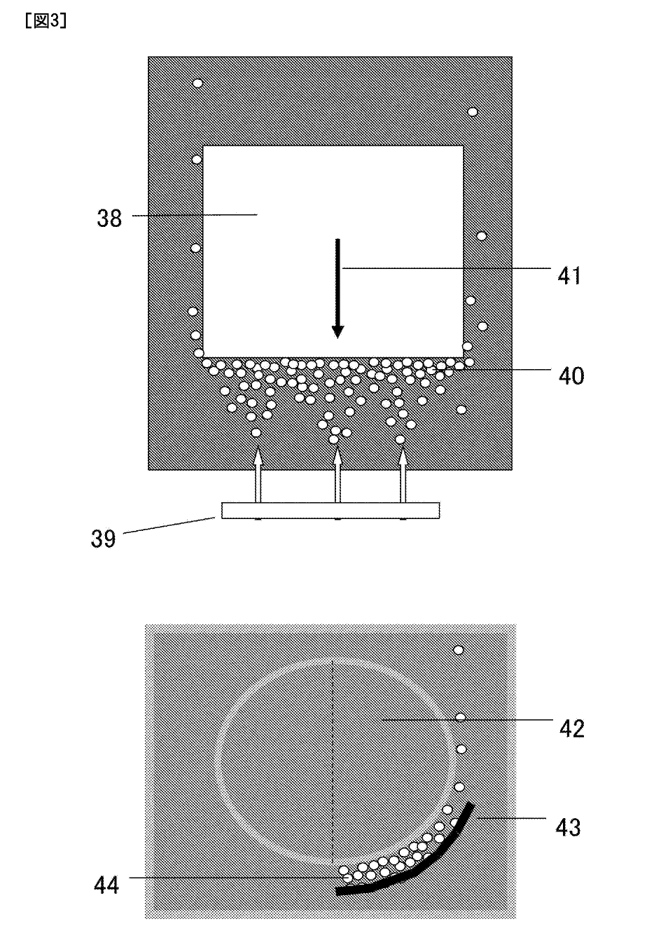

FIG. 3 is a conceptual diagram of a method of moving a float by injecting bubbles into the liquid to increase or decrease the specific gravity of the liquid.

In claim 6, the electricity generator using the “fluid specific gravity increase-decrease method” is described.

At the bottom of the float 38 moving up-and-down, the bubbles 40 are injected with the injection device 39. The liquid at the bottom becomes a liquid mass containing bubbles, the specific gravity decreases, the buoyancy generated in the float 38 decreases, and the float 38 goes downward 41. When the injection is stopped, bubbles are discharged, the buoyancy is restored, and the float 38 goes upward. In the case of the float moving up-and-down, the injection and the injection stop is repeated.

Instead of bubbles 40, air may be injected at the bottom of the float to intercept the contact between the float and the liquid. Combined use of bubble injection and air injection is effective.

In Claim 8, the power generation device using the “liquid pressure reduction operation” of the “liquid pressure imbalance method” is described. The bubbles 44 are injected using the injection device 43 to the float 42 to be rotated. In the case of a rotary type float, injection is performed continuously. Combined use of bubble injection and air injection is efficient.

The basic composition of the device according to claims 6 and 8 are a float and an injection device, and very simple, and can be installed not only inside a container but also in a lake or in a sea. Therefore, it is possible to increase the size. The larger the size, the larger the output compared with the driving power by the square cubic law (0015). In the sea, it is easy to install float of about 1 million cubic meters, and the generated buoyancy reaches about 1 million tons.

“Gap Operation Type Float”

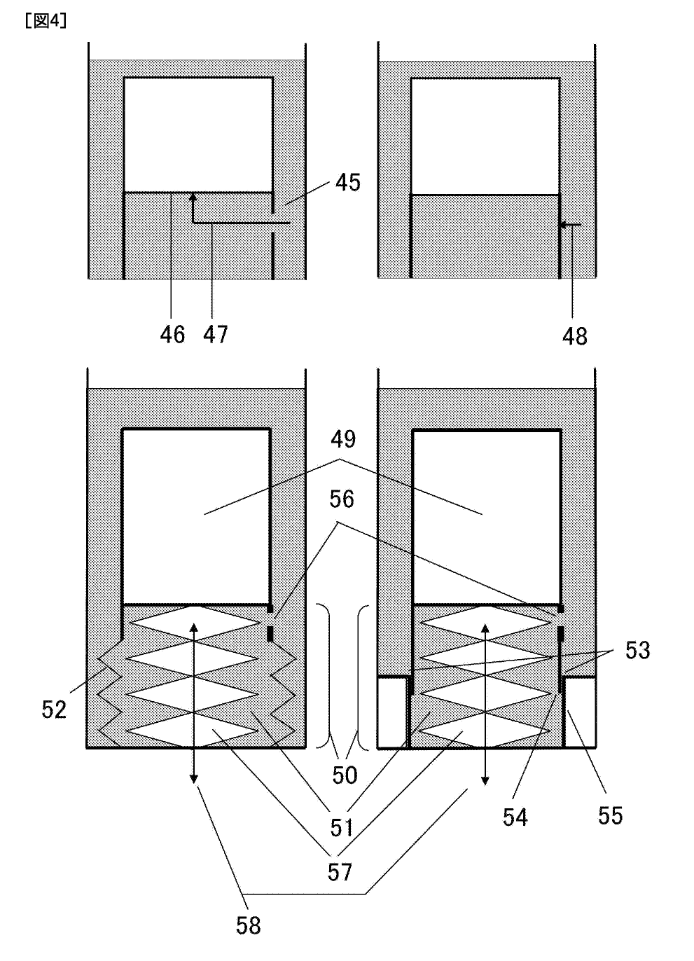

FIG. 4 is an explanatory view of the “liquid pressure interception method” and a conceptual diagram of the “gap operation type float”.

Buoyancy does not occur in the piers built in the river flow. As described “The buoyancy can be defined as ‘the upward force by the fluid which acts on the bottom of the object in the fluid in the gravitational field’ (0008)”, there is no “bottom” that receives the upward pressure of the liquid. Conversely, even if the bottom exists, if no upward pressure of liquid acts on the bottom, buoyancy also does not occur.

A “Gap Operation Type Float” is Described in Claim 7.

Where the orifice 56 is opened wide, upward liquid pressure acts on the bottom of the float upper part 49. That is, buoyancy has arisen. If the orifice 56 is closed, the liquid pressure conduction is intercepted, buoyancy will be extinguished, the float upper part 49 will go downward and the float lower part 50 will contract simultaneously.

At this time, if the “bellows-in-gap” 57 do not exist in the gap, the float lower part 50 cannot be contracted because the inside is filled with the liquid 51. However, since the float upper portion 49 pushes down the bellows-in-gap 57 and the bellows-in-gap 57 contracts while discharging 58 the air inside, the lower portion 50 of the float can contract without changing the amount of the liquid 51.

If the orifice 56 is opened, the float upper part 49 recovers buoyancy again, it goes upward while expanding the float lower part 50, and simultaneously the bellows-in-gap 57 also will be elongated while inhaling 58 air inside.

The float lower part 50 is expanded and contracted, by the bellows structure 52, or by the cylinder structure made of combination of the inner pipe 54 of the float lower part and the outer case 55 which forms a gap. The cylinder is equipped with the sealing mechanism 53.

The “gap operation type float” uses very simple operation method of opening and closing of an orifice, and driving power is very small. Therefore, it can be driven with “mechanism (automatic machine)” which closes the orifice in the final stage of the rise of the float upper part, and opens in the final stage of the descent of that, using a mechanical method like lever operation.

Rotary Type Float

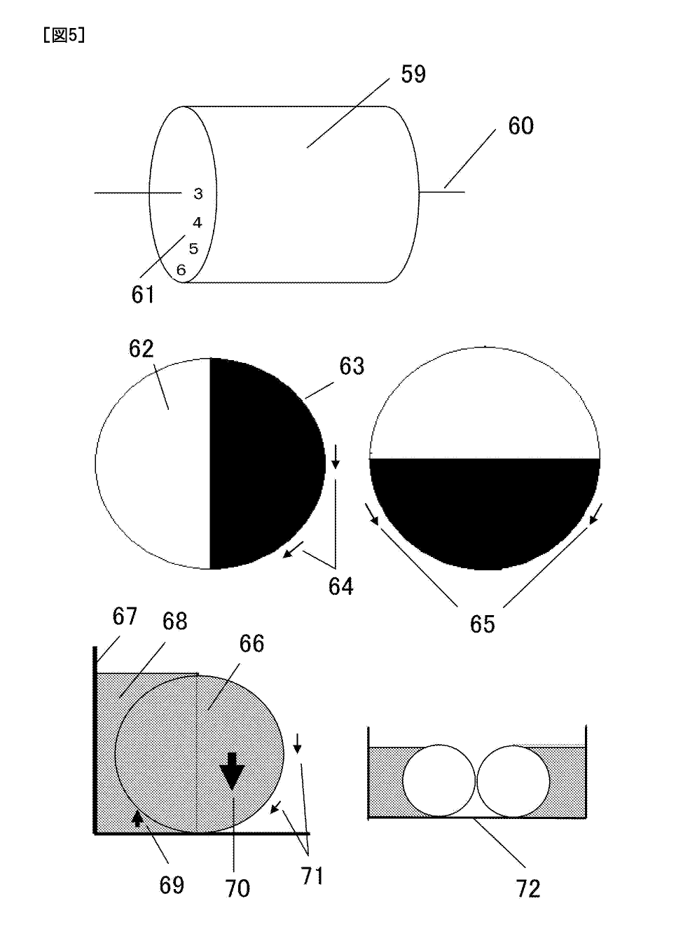

FIG. 5 is a conceptual diagram of the device using the rotary type float and its principle, i.e., “imbalance immersion”.

Should not be bound by the stereotype that a float floats. In the present invention, the float is a tool for capturing the fluid pressure in the upward direction.

The “rotary type float” is indicated to Claim 8.

The “gas interception” (0043) of the “liquid pressure interception operation” is a method injecting a air with an arc-shaped injection device (43) close to the rotary type float (42) to intercept contact between the rotary type float and the liquid, and is similar with the above “liquid pressure reduction operation” (FIG. 3).

The “imbalance immersion” is a method that does not use driving power at all. The rotary type float 66 filled with the same liquid as the liquid 68 is installed in the container 67 aiming at “imbalance immersion”, and the liquid 68 is only filled in the predetermined portion. In the figure, the left-hand side of the float 66 is immersed, and left-hand side has no weight due to the buoyancy 69. On the other hand, the right-hand side of the float is not immersed, a torque 71 is generated by the weight 70, and a float rotates clockwise. The method 72 of combining two rotary type floats is also effective.

In this method leakage becomes a problem. A method to seal the gap between the float and the container is necessary. Using mercury for the liquid is extremely effective.

Wired Aircraft

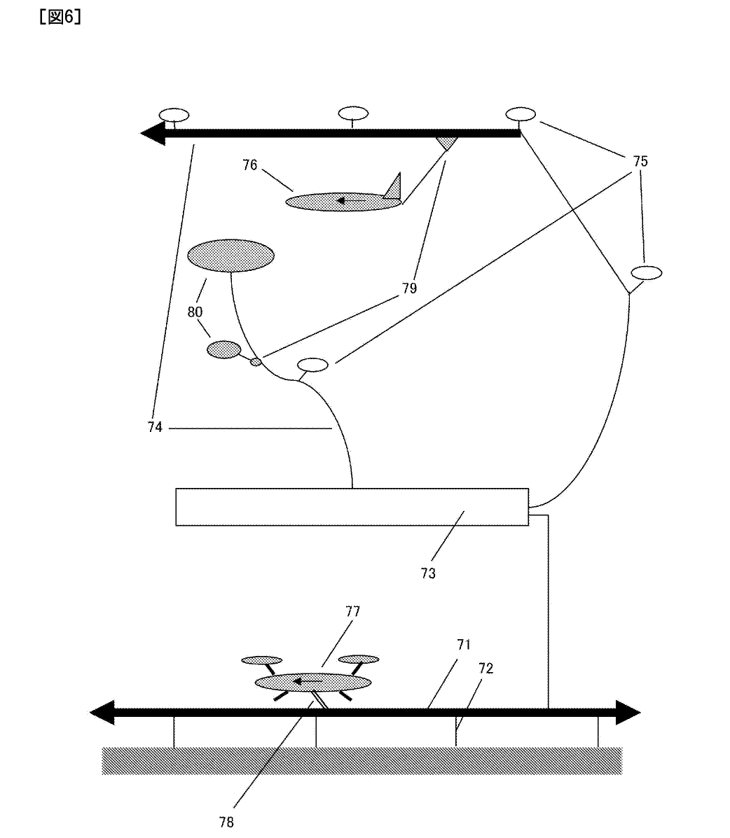

FIG. 6 is a conceptual diagram of the “moving type wired aircraft” and the “fixed-position type wired aircraft” using the “stationary type wire” and the “floated type wire”. It is a fixed idea to lay the power transmission line on the ground with a steel tower. If there is a trolleybus, a trolley airplane is also possible.

The electric power supply 75 (sic) uses the electricity generator of the present invention, the power network in which the electricity generator of the present invention is interconnected, and the “stationary type wire”. It is possible to transmit electric power from “stationary type wire” to “stationary type wire” 73 (sic) or “floated type wire” 76 (sic). The “stationary type wire” 73 (sic) connected to the electric power supply 75 (sic) is installed on the ground or a building by fixtures such as wire pillars 74 (sic). The “moving type wired aircraft” 79 (sic) flying at a relatively low speed flies with power from the “stationary type wire” 73 (sic) using the “stationary type electricity collecting device” 80 (sic) or the “electricity collecting drone” 81 (sic).

Since the electric power by the power generation device of the present invention, is low cost very much, the low-voltage power transmission with a large transmission loss is also admissible. Since it is low-voltage, it can install in a living area. By laying the low-voltage “stationary type wires” in various separate places, the “moving type wired aircraft” can move long distance as if “frog jumping” by repetition of flight by electricity collecting and self flight by battery.

The “floated type wire” 76 (sic) is constructed in air by the “wire support aircraft” 77 (sic), while supporting the wire which is linked to the electric power supply 75 (sic). The “moving type wired aircraft” 78 (sic) flies while collecting electricity form the “floated type wire” 76 (sic) using the “electricity collecting drone” 81 (sic).

The “floated type wire” 76 (sic) does not necessarily have to be continuous to the destination. The “floated type wire” is dotted in the flight path, and the “moving type wired aircraft” 78 (sic) can reach the destination while flying by the “frog jumping”.

The “fixed-position type wired aircraft” 82 (sic) is hanging the “floated type wire” 76 (sic) connected to the electric power supply 75 (sic), staying at a regular position, performs business. Or it is possible to fly within the wired area by collecting electricity from the hung “floated type wire” 76 (sic) using the “electricity collecting device” 81 (sic). When the wire is long, it can be supported by the “wire support aircraft” 77.

Even with “fixed position type”, it is possible to hang the electricity generator of the present invention and to move to the destination while collecting electricity from the electricity generator.

High Temperature Bubble Injection Type Water Maker

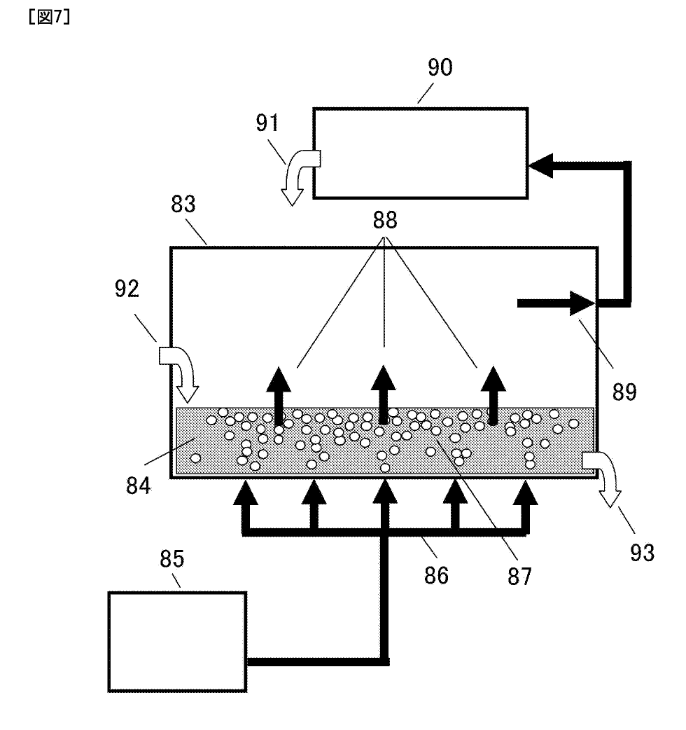

FIG. 7 is a conceptual diagram of the high temperature bubble injection type water maker. The raw water 84 is put into the container 83, and air is heated to several hundreds of degrees by the “device for heating the air and pressing it out into the container” 85 using the “buoyancy type press pump” of claim 12 of the present invention. The “buoyancy type press pump” of the present invention is characterized by low rotation speed large capacity. The compression ratio is increased to raise the temperature of the air, and the air is bubbled and injected into the raw water 84 using the injector 86. The raw water 84 boils 88, water vapor fills the container, it is pressed out 89 of the container, moves to the condenser 90, and becomes distilled water 91. Raw water is appropriately poured 92, and discharged 93.

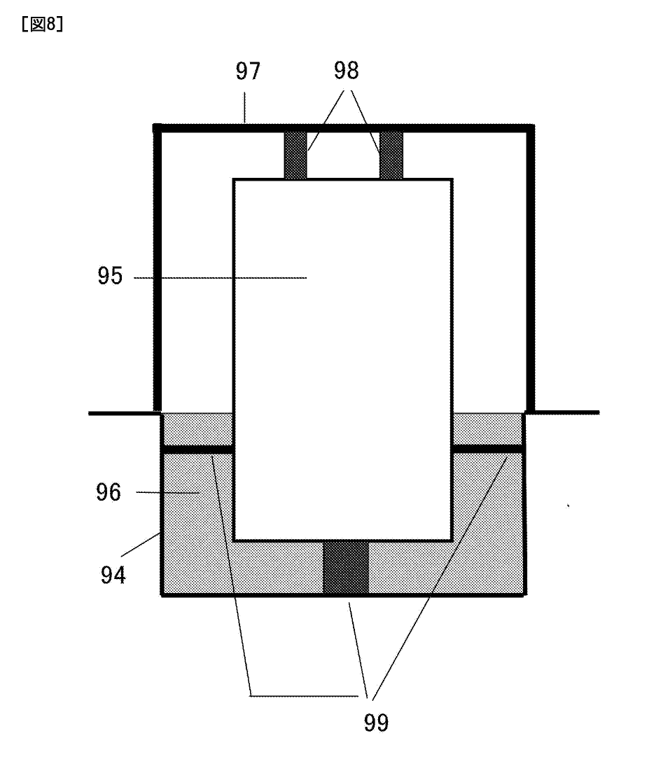

FIG. 8 is a conceptual diagram of “hanging type seismic isolator using buoyancy”. The power generation device of the present invention has a vulnerable field to an earthquake, and as a solution to this problem, a seismic isolator using buoyancy is used.

A structure 95 for storing the power generation device is floated on the water 96 in the container 94, and the structure is hung from the “column support for hanging” 97 by the hanging device 98 using an elastic body.

Normally, it is fixed with the fixing device 99. When the earthquake occurs, fixation of the fixing device 99 is canceled.

Alternatively, the portion, fixing the bottom portion of the structure, may be an elastic body and fixed at all times. The structure supported, with top and bottom, vertically by the hanging device and the bottom fixing device are highly stable.

The present seismic isolator can also be used for isolation of buildings. The configuration is the same, the container 94 is an excavation hole, and the structure 95 corresponds to a building.

Tandem Car

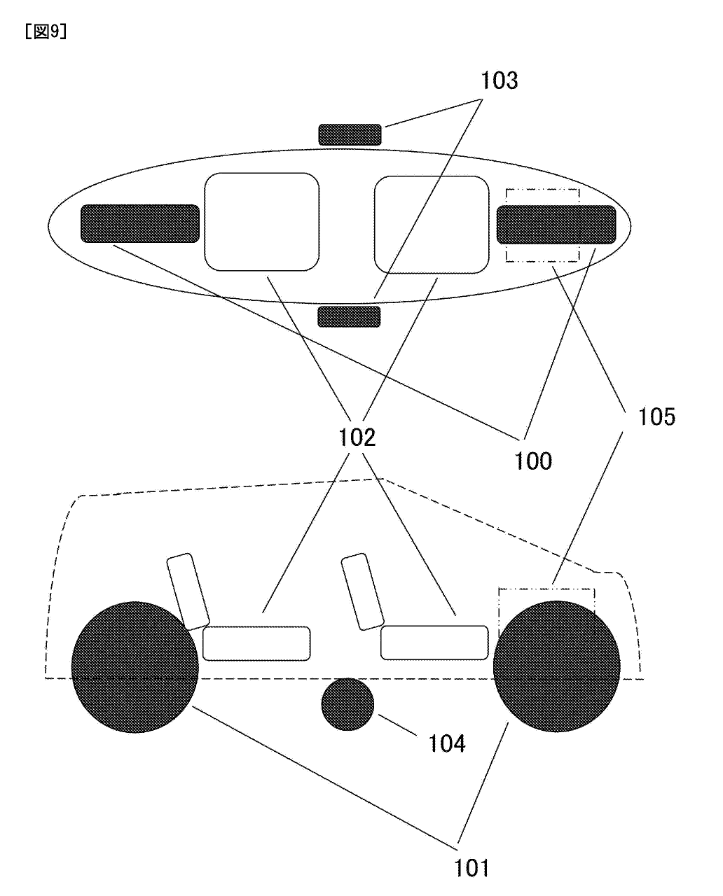

FIG. 9 is a simplified plan view and a three-dimensional view of a tandem automobile.

It is a passenger car that is equipped with the power generation device of the present invention and can continue running without fuel. In order to reduce the burden on the electricity generator, it is a lightweight body. It combines the characteristics of a four-wheel passenger car and a motorcycle, making it compatible with comfort and lightness. The running wheels 100 and 101 are tandem two wheels, and the seat 102 is likewise tandem. In order to prevent falling, the auxiliary wheels 103 and 104 are provided on the left and right sides of the car body. The engine 105 is the electricity generator of the present invention and a battery, but may be a combination of a conventional engine, the electricity generator of the present invention and the battery.

1. A “power generation method”, comprising:
a “power generation device” including a combination of an “input”, an “output”, and a “driving power”, wherein
the “input” is a “liquid pressure” in the gravitational field,
the “output” is a power of a kinetic energy of a float, and
the “driving power”, for converting the “input” to the “output”, is a part of the “output” on the basis of realization of a “relation of generated power>driving power” for enabling “self-supply of driving power”; and
a “liquid pressure operation method” which is a method for generating the “power of the kinetic energy of the float” by operating the “liquid pressure”, wherein
the “power generation method” makes it possible to drive itself by a part of the power generated by itself, and generates industrially usable power, using the “power generation device” and the “liquid pressure operation method”, wherein
the “liquid pressure operation method” comprises:
1. a “liquid level increase-decrease method” by which the “float” is moved up-and-down by increasing-decreasing the level of the “liquid” holding the “float moving up-and-down”;
2. a “fluid specific gravity increase-decrease method” by which the “float” is moved up-and-down by increasing-decreasing the specific gravity of the “liquid” holding the “float moving up-and-down” to increase-decrease the “liquid” pressure acting upward at the “float” bottom;
3. a “liquid pressure interception method” by which the “float” is moved up-and-down by intercepting intermittently the “liquid” pressure acting upward at the bottom of the “float moving up-and-down”; and
4. a “liquid pressure imbalance method” by which the “float” is rotated vertically by imbalancing the “liquid” pressure, acting upward at the bottom of the “float rotating vertically”, between the left-hand side of the bottom and the right-hand side of the bottom to generate a torque,
the “power generation device”, corresponding to the four kinds of the “liquid pressure operation method”, comprises:
a “power generation device” which uses the above 1st kind “liquid level increase-decrease method” in combination with the “liquid”, the “float moving up-and-down”, a container for storing the “liquid” and the “float”, and a device for carrying out the “liquid level increase-decrease method”, and generates a power by moving the “float” up-and-down in the liquid by carrying out the “liquid level increase-decrease method”;
a “power generation device” which uses the above 2nd kind “fluid specific gravity increase-decrease method” in combination with the “liquid”, the “float moving up-and-down”, and a device for carrying out the “fluid specific gravity increase-decrease method”, and generates a power by moving the “float” up-and-down in the liquid by carrying out the “fluid specific gravity increase-decrease method”;
a “power generation device” which uses the above 3rd kind “liquid pressure interception method” in combination with the “liquid” and a device for carrying out the “liquid pressure interception method”, and generates a power by moving the “float” up-and-down in the liquid by carrying out the “liquid pressure interception method”; and
a “power generation device” which uses the above 4th kind “liquid pressure imbalance method” in combination with the “liquid”, the “float rotating vertically”, and a device for carrying out the “liquid pressure imbalance method”, and generates a power by rotating the “float” in the liquid by carrying out the “liquid pressure imbalance method”, wherein
for the “driving power”, in the case where the “self-supply of driving power” is used, one or two-kinds is selected and used from a group comprising:
a part of power which is generated by the “power generation device”; and
a part of electric power generated using the power which is generated by the “power generation device”, or
in the case where the “self-supply of driving power” is not used, one or a plurality of kinds is selected and used from a group comprising:
a power supplied by a separate power generation device separate from the “power generation device”;
an electric power received from a power network system to which the “power generation device” is connected;
a running water; and
a human power.

2. A “control device of driving power”, which selects a driving power for the “power generation device” according to claim 1 from two or more power sources, and adjusts the selected power to power suitable for driving the “power generation device”, for the purpose of driving the “power generation device” with the adjusted power, wherein
the “control device of driving power”
selects the power for driving the “power generation device” from a power source group comprising:
a part of a “power” which is generated by the “power generation device”;
a “part of an electric power” generated using a power which is generated by the “power generation device”;
an electric power of a battery charged by the “part of the electric power”;
a power generated by a power generation device separate from the “power generation device”;
an electric power generated by an electricity generator separate from the “power generation device”; and
an electric power received from a power network system to which the electric power, generated with the power generated by the “power generation device”, is connected,
adjusts the selected power to power suitable for driving the “power generation device”, starts or stops the “power generation device”, and adjusts an output of the “power generation device” using the “adjusted” power.

3. (canceled)

4. A “power generation device” using the “liquid level increase-decrease method” described in claim 1, comprising:
the “liquid”, the “float moving up-and-down”, the “container” for storing the “liquid” and the “float moving up-and-down”;
a bellows-in-gap for the purpose of reducing the liquids existing in a “gap” below the bottom of the “float moving up-and-down” installed in the “gap”,
which has one or a plurality of features:
composed of one bellows or a plurality of bellows,
having a unified form of rhombus shapes connected vertically in elevational view of the bellows, for the purpose of offsetting a liquid pressure acting on the bellows downward with a liquid pressure acting on the bellows upward,
the topmost part of the bellows being fixed to the bottom of the “float moving up-and-down” with a space,
the bottom of the bellows being fixed to the bottom of the “gap”, and
whole of the bellows being sealed so that internal gas does not leak out, or the air inside the bellows communicating with the open air so that the air is discharged and inhaled according to the contraction and extension of the bellows, and moreover
has more feature usable by arbitrarily selecting from a group:
the bellows-in-qap being made in a rhombus shape by combining parts of umbrella shape having a hole in the center, for the purpose of easy fabrication of bellows,
a plan view of the bellows-in-qap being a square or a rectangle suitable for clustering bellows and combining bellows, and
arranging two or more bellows by combining adjacent “mountain” and “valley” of bellows;
a “liquid level increase-decrease device” for the purpose of increasing or decreasing the liquid level of the “liquid” which executes one or a plurality of operations selected from an operation group:
a operation draining the “liquid” from the “container” or pouring the “liquid” into the “container”,
an operation inserting or pulling out an object in the “liquid”,
an operation increasing or decreasing the volume of the “float”, and
an operation expanding or contracting an expand-able-contract-able object in the “liquid”; and
a “device for changing an up-and-down motion into a rotational motion” as an option, and a “dynamo” as an option, wherein
the “power generation device” leads the “float” to an “up-and-down motion” by the “liquid level increase-decrease device”, or changes the “up-and-down motion” to a “rotational motion” by the optional “device for changing an up-and-down motion into a rotational motion”, drives the “dynamo” by the “rotational motion”, and generates electric power.

5. A “power generation device” using the “running water” in the “liquid level increase-decrease method” described in claim 1, comprising:
the “running water”, the “float moving up-and-down”, a “container” for storing the “running water” and the “float moving up-and-down”;
a bellows-in-qap for the purpose of reducing the liquids existing in a “gap” below the bottom of the “float moving up-and-down” installed in the “gap”,
which has one or a plurality of features:
composed of one bellows or a plurality of bellows,
having a unified form of rhombus shapes connected vertically in elevational view of the bellows, for the purpose of offsetting a liquid pressure acting on the bellows downward with a liquid pressure acting on the bellows upward,
the topmost part of the bellows being fixed to the bottom of the “float moving up-and-down” with a space,
the bottom of the bellows being fixed to the bottom of the “gap”, and
whole of the bellows being sealed so that internal gas does not leak out, or the air inside the bellows communicating with the open air so that the air is discharged and inhaled according to the contraction and extension of the bellows, and moreover
has more feature usable by arbitrarily selecting from a group:
the bellows-in-qap being made in a rhombus shape by combining parts of umbrella shape having a hole in the center, for the purpose of easy fabrication of bellows,
a plan view of the bellows-in-qap being a square or a rectangle suitable for clustering bellows and combining bellows, and
arranging two or more bellows by combining adjacent “mountain” and “valley” of bellows;
a “liquid level increase-decrease device” for executing the pouring and draining of the running water using the up-and-down motion of the “float”, which executes one or a plurality of operations selected from an operation group:
1. an operation always pouring the “running water” into the “container” and intermittently draining the running water more than amount of the pouring,
2. an operation always draining the “running water” from the “container” and intermittently pouring the running water more than amount of the draining, and
3. an operation performing by turns the pouring of the “running water” into the “container” and the draining of the “running water” from the “container”; and
a “device for changing an up-and-down motion into a rotational motion” as an option, and a “dynamo” as an option, wherein
the “power generation device” leads the “float” to an “up-and-down motion” using the “liquid level increase-decrease device” which executes one operation selected from an operation group:
in the above 1st operation, starting the draining more than amount of the pouring, using the “float” moved upward to a predetermined position, while always pouring the “running water” into the “container”,
in the above 2nd operation, starting the pouring more than amount of the draining, using the “float” moved downward to a predetermined position, while always pouring the “running water” into the “container”,
in the above 3rd operation, starting the draining after stopping the pouring, using the “float” moved upward to a predetermined position, and starting the pouring after stopping the draining, using the “float” moved downward to a predetermined position, and
an operation, draining the water from the “container”, and pouring the drained water into the “container”; or
changes the “up-and-down motion” to a “rotational motion” by the optional “device for changing an up-and-down motion into a rotational motion”, drives the “dynamo” by the “rotational motion”, and generates the electric power.

6. A “power generation device” using the “fluid specific gravity increase-decrease method” described in claim 1, comprising:
the “liquid” and the “float moving up-and-down”;
a bubble injection device injecting bubbles intermittently into the “liquid” for the purpose of making the “liquid”, which is wrapping the bottom of the “float”, into a liquid mass containing bubbles, for the purpose of increasing and decreasing the “fluid” specific gravity;
an air injection device injecting air intermittently to the bottom of the “float” for the purpose of intercepting the bottom of the “float” to contact with the “liquid”; and
a “device for changing an up-and-down motion into a rotational motion” as an option, and a “dynamo as an option, wherein
the “power generation device” leads the “float” to an “up-and-down motion” by executing one or two operations selected from an operation group:
an operation intermittently injecting bubbles into the liquid wrapping the bottom of the “float” by driving the “bubble injection device”; and
an operation intermittently injecting air to the bottom of the “float” by driving the “air injection device”, or
changes the “up-and-down motion” to a “rotational motion” by the optional “device for changing an up-and-down motion into a rotational motion”, drives the “dynamo” by the “rotational motion”, and generates the electric power.

7. A “gap operation type float” being the “power generation device” using the “liquid pressure interception method” described in claim 1, comprising:
the “liquid”; a “float upper part moving up-and-down”; a “float lower part”; a “gap”; an “orifice”; an “orifice open-close device”;
a bellows-in-qap for the purpose of reducing the liquids existing in a “gap” below the bottom of the “float moving up-and-down” installed in the “gap”,
which has one or a plurality of features:
composed of one bellows or a plurality of bellows,
having a unified form of rhombus shapes connected vertically in elevational view of the bellows, for the purpose of offsetting a liquid pressure acting on the bellows downward with a liquid pressure acting on the bellows upward,
the topmost part of the bellows being fixed to the bottom of the “float moving up-and-down” with a space,
the bottom of the bellows being fixed to the bottom of the “gap”, and
whole of the bellows being sealed so that internal gas does not leak out, or the air inside the bellows communicating with the open air so that the air is discharged and inhaled according to the contraction and extension of the bellows, and moreover
has more feature usable by arbitrarily selecting from a group:
the bellows-in-gap being made in a rhombus shape by combining parts of umbrella shape having a hole in the center, for the purpose of easy fabrication of bellows,
a plan view of the bellows-in-qap being a square or a rectangle suitable for clustering bellows and combining bellows, and
arranging two or more bellows by combining adjacent “mountain” and “valley” of bellows;
a “liquid reservoir” as an option; and
a “device for changing an up-and-down motion into a rotational motion” as an option, and a “dynamo” as an option, wherein
the “gap operation type float” is characterized in that:
the “float upper part” generates a buoyancy in response to liquid pressure at the bottom,
the “float lower part” has a “gap” filled with a liquid inside, expands and contracts with an expanding-contracting structure, and moves the “float upper part” upward and downward,
the “gap” filled with the “liquid” conducts a pressure of the “liquid”, which wraps the “gap operation type float”, to the bottom of the “float upper part”,
the “orifice” is prepared at the “float lower part”, transmits, when opened, the pressure of the “liquid” wrapping the “gap operation type float” to the “gap”, and intercepts the transmission”, when closed,
the “orifice open-close device” executes opening and closing of the “orifice” mechanically by executing one or a plurality of operations selected from an operation group:
an operation mechanically opening the “orifice” by a “climbing power of the float” and mechanically closing the “orifice” by a “downward power of the float”;
an operation opening and closing the “orifice” with electric power; and
an operation mechanically opening and closing the “orifice” with a power generated by a separate power generation device separate from the “gap operation type float”,
the “bellows-in-gap” is prepared in the “gap” and expands and contracts in phase with the upward and download movement of the “float upper part”,
the optional “liquid reservoir”, other than the method using the “bellows-in-gap”, may be used, wherein the liquid reservoir is a device able to increase and decrease its volume, prepared by connecting to the float lower part, absorbs the liquid from the gap when the float moves downward, and pushes and moves the liquid into the gap when the float moves upward,
two combined sets of the gap operation type float may be used to move the liquid in the gaps mutually between them, for the purpose of absorbing the liquid discharged from the gap when the float moves downward, and pushes and moves the liquid into the gap when the float moves upward,
the liquid reservoir and the bellows-in-qap may be used together,
the “gap operation type float” is installed in the “liquid” and leads the “float” to an “up-and-down motion” using the “orifice open-close device” by executing two operations:
an operation moving the “float upper part” downward by closing the “orifice”; and
an operation moving the “float upper part” upward by opening the “orifice”, or
changes the “up-and-down motion” to a “rotational motion” by the optional “device for changing an up-and-down motion into a rotational motion”, drives the optional “dynamo” by the “rotational motion”, and generates the electric power.

8. A “rotary type float” being the “power generation device” using the “liquid pressure imbalance method” described in claim 1, comprising:
the “liquid”, and the “float” rotating vertically;
a “device for executing the liquid pressure imbalance method” for making liquid pressure, which is acting on a bottom right-hand side and a bottom left-hand side of the float, imbalance, for the purpose of generating a torque in the float, including:
a “bubble injection device” aiming at covering a part of the “float” with a liquid mass containing bubbles,
a “gas injection device” aiming at intercepting a part of the “float” to contact with the “liquid”,
an “object covering a part of float” aiming at intercepting a part of the “float” to contact with the “liquid”, and
a “container storing the float and the liquid” aiming at not dipping a part of the float in the liquid; and
a “dynamo” as an option, wherein
the “rotary type float” executes one or a plurality of operations by selecting the operation from an operation group:
an operation driving the “bubble injection device”, injecting bubbles to an injection area at a lower part periphery of the float wherein the injection area is any one of a part of clock position right-hand side or the whole and a part of clock position left-hand side or the whole, and covering the injection area with the liquid mass containing bubbles;
an operation driving the “gas injection device” using the “control device of driving power”, injecting gas to an injection area at a lower part periphery of the float wherein the injection area is any one of a part of clock position right-hand side or the whole and a part of clock position left-hand side or the whole, and intercepting the injection area to contact with the liquid;
an operation covering an interception area at a lower part periphery of the float wherein the interception area is any one of a part of clock position right-hand side or the whole and a part of clock position left-hand side or the whole, with the “object covering a part of float”, and intercepting the interception area to contact with the liquid with the object; and
an operation, using the “container storing the float and the liquid”, storing the liquid and the float into the container which is made to make a not-dipped-area at a lower part periphery of the float be in a state not dipped wherein the not-dipped-area is any one of a part of clock position right-hand side or the whole and a part of clock position left-hand side or the whole, and
the “rotary type float” leads the float to a rotational motion by the execution of the selected operation, which makes the liquid pressure acting on the bottom right-hand side and the bottom left-hand side of the float imbalance, makes the weight of the right-hand side and the left-hand side of the float imbalance, and makes a torque in the float occur, or
drives the optional “dynamo” by the “rotational motion”, and generates the electric power.

9. (canceled)

10. An electricity supply system having an “electricity generation facility” group for generating electric power with the “power generation device” using the “power generation method” according to claim 1 and an “electricity transmission facility” group for distributing the electric power generated by the “electricity generation facility”, wherein
the “electricity generation facility” group comprises:
a “stationary type electricity generator” being fixed and installed in a fixed place, and supplying electric power to a specific use;
an “electric-power plant being large-scale power generation device aiming at transmitting electricity to a general use; and
a “portable electricity generator” being possible to be carried in a means of transportation and to move, and
the “electricity transmission facility” group is a group of “electricity transmission facilities” characterized by transmitting an electric power generated with the “electricity generation facility”, or characterized by being used as a part of a power network system to which the “electricity transmission facility” is connected, comprises:
a “stationary type wire” supported with an instrument for supporting the wire and installed in a fixed place;
a “floated type wire” supported in air by an aircraft and installed in air in floating;
a “wire support aircraft” having one or a plurality of functions in a group of a function for supporting the wire in air while flying and collecting electricity from the floated type wire, a function for laying the wire in air, and a function mending the wire; and
a “direct-current electricity supply device” supplying electric power generated by the “electricity generation facility” to direct current driven electric appliances with the voltage that the electrical appliances use.

11. (canceled)

12. A “buoyancy type pump” or a “buoyancy type press pump” being the “power generation device” using the “power generation method” according to claim 1 to which a function of “pump” or “press pump” of reciprocation type is added, comprising:
the “power generation device”, a piston, a cylinder, and a valve, wherein
the “piston” is inserted in the “cylinder”, or the float of the “power generation device” is used as the “piston” and inserted in the “cylinder”, the “power generation device” is driven, and the “piston” is reciprocated in the “cylinder”,
for the pump, a fluid is inhaled and exhaled by an operation of the “valve”, and
for the press pump, a fluid is inhaled, compressed, and exhaled by an operation of the “valve”.

13. A “moving type wired aircraft” flying with the “power generation device” using the “power generation method” according to claim 1, comprising:
a “stationary type wire” being fixed and installed in a fixed place, or a “floated type wire” supported in air by an aircraft;
an “electric power supply” using the “power generation method” according to claim 1;
a “wired aircraft main body” including an “electric motor”, a “battery”, a “fixed wing”, a “rotor”, an optional “power generation device”, and an “internal-combustion engine” as an option; and
an “electricity collecting device”, wherein
for the “electricity collecting device”, there are two types: a “stationary type electricity collecting device”; and a “electricity collecting drone”, wherein
the “stationary type electricity collecting device” is fixed and installed on the “wired aircraft main body”, collects the electricity from the “stationary type wire” or the “floated type wire”, and supplies the collected electric power to the “wired aircraft main body”, and
the “electricity collecting drone” is an aircraft aiming at collecting electricity and connected to the “wired aircraft main body” with a cable, collects the electricity from the “stationary type wire” or the “floated type wire”, and supplies the collected electric power to the “wired aircraft main body”, while flying, and
the “moving type wired aircraft”
flies by collecting electricity from the “stationary type wire” or the “floated type wire” connected to the “electric power supply” using the “stationary type electricity collecting device” or the “electricity collecting drone”,
flies using the “fixed wing”, or the “rotor”, or both of the “fixed wing” and the “rotor”, and
flies using electric power from one or plurality of devices selected from the “battery”, the optional “power generation device”, and the optional “internal-combustion engine”, on board, while not collecting electricity from the “stationary type wire” or the “floated type wire”.

14. A “fixed-position type wired aircraft” flying at rest or vertically in a certain area utilizing the “power generation device” using the “power generation method” according to claim 1, comprising:
a “stationary type wire” being fixed and installed in a fixed place, or a “floated type wire” supported in air by an aircraft;
an “electric power supply” using the “power generation method” according to claim 1;
a “fixed-position type wired aircraft main body” including an “electric motor”, a “rotor”, and a “fixed wing”;
a “business-use device for business purpose”; and
an “electricity collecting drone” being an aircraft aiming at collecting electricity, wherein
the “fixed-position type wired aircraft”
flies, while hanging the “floated type wire” connected to the “electric power supply” and receiving electricity from the “floated type wire”, or flies, using the optional “electricity collecting drone”, while collecting electricity from the “stationary type wire” or the “floated type wire”,
flies using the “fixed wing”, or the “rotor”, or both of the “fixed wing” and the “rotor”, and
executes businesses using the “business-use device for business purpose”, while flying at fixed position at rest.

15. The “fixed-position type wired aircraft” according to claim 14, wherein
the “fixed-position type wired aircraft” carries out one business in a group:
a “takeoff-and-landing auxiliary business”, aiming at making an aircraft, which is characterized by horizontal takeoff-and-landing, perform takeoff and landing vertically, carried out by holding an aircraft for takeoff, going up with the aircraft, and releasing the aircraft to make it fly at a takeoff point, and by catching an aircraft for landing in air, and carrying the aircraft to a landing point while descending;
a “communication business” carried out by staying at a fixed position in air, executing a communication business including a relay base business; and
a “forestry business” including felling of trees, moving the trees cut-down, and afforestation, while flying certain fixed area over a forest.

16. A “bubble injection type water maker” making water with heated air with the “power generation device” using the “power generation method” according to claim 1, comprising:
the “power generation device”; a “container” storing “raw water”; a “device heating air and pressing out into the container”; and a “condenser”, wherein
the “device heating air and pressing out into the container”
includes a “press pump”, a “heater”, and a “pump”, which use the “power generation method” according to claim 1,
heats the air using selected one or two of the “press pump” and the “heater”, and
presses out the heated “air” using selected one or two of the “press pump” and the “pump”,
the “bubble injection type water maker” makes water by the operations:
an operation driving the “device heating air and pressing out into the container”, heating the air, and pressing out the heated air as bubbles into the raw water in the container; and
an operation condensing the water vapor discharged from the container using the “condenser”.

17. A “buoyancy jack” making a heavy load go up and down by buoyancy using the “liquid level increase-decrease method” described in claim 1, comprising:
a float; a liquid; a container storing the float and the liquid; and a device for pouring and draining the “liquid”, wherein
the “buoyancy jack” makes the heavy load go up and down
by storing the “float” in the “container”,
by driving the “device for pouring and draining”, and
by executing two operations:
an operation pouring the “liquid” into the “container” to make the float go up; and
an operation draining the “liquid” from the “container” to make the float go down.

18. A business method of mining and manufacturing utilizing the “power generation device” using the “power generation method” according to claim 1, selected from a group comprising:
a business method of chemicals manufacture utilizing the “power generation device”;
a business method of aluminum refinement utilizing the “power generation device”;
a business method of iron manufacture by an electric furnace utilizing the “power generation device”;
a business method of carbon fiber manufacture utilizing the “power generation device”;
a business method of hydrocarbon product manufacture which is manufactured by compounding carbon dioxide collected out of the atmosphere and hydrogen obtained by electrolyzing water, utilizing the “power generation device”; and
a business method of marine-resources development executed using a submarine boat driven utilizing the “power generation device”.

19. (canceled)

20. A fishing implement or a fishing facility utilizing the “power generation device” using the “power generation method” according to claim 1, selected from a group comprising:
a fishing boat using the “power generation device”;
a submergible fishing boat able to cruise underwater and operated manned or unmanned using the “power generation device”;
an aeration device using the “power generation device”;
a fishing implement using the “power generation device”;
a fishery information machine and device, for the purpose of detecting the information in a fishery, installed in the fishery, which detects desired information there and transmits the information to a fishery operator, using the “power generation device”;
a fish finder being installed underwater regular position, or moving underwater, or being carried on a fishing boat, using the “power generation device”;
a fish preserve using the “power generation device”;
an artificial fish reef equipped with an aeration device and a fishes capture device, using the “power generation device”; and
a marine ranch using the “power generation device”.

21. A building or a building facility utilizing the “power generation device” using the “power generation method” according to claim 1, selected from a group comprising:
a building installed in the ground, water surface, underwater, or a sea bed which is using the “power generation device” as a private electricity generator;
a factory installed in the ground, water surface, underwater, or a sea bed which is using the “power generation device” as a private electricity generator;
a warehouse using the “power generation device” as a private electricity generator;
a data center using the “power generation device” as a private electricity generator; and
a snow melting system for a building using the “power generation device” as a private electric generator.

22. A hanging type seismic isolator using buoyancy used for the “power generation device” using the “power generation method” according to claim 1, or used for a building equipped with the “power generation device”, or used for a ground where the “power generation device” is installed, comprising:
a “container or an excavated hole”;
a “quake-absorbing object structure” being the “power generation device”, or the building equipped with the “power generation device”, or the ground where the “power generation device” is installed;
a “liquid”, a “column support for hanging”, and a “hanging device” using an elastic body;
a “fixing device” which fixes the “quake-absorbing object structure” and releases the “fixing”;
a “pouring-draining device” as an option which pours or drains a liquid;
a “bubble injection device” as an option which injects bubbles into the “liquid” stored in the “container” or the “excavated hole”; and
a “wind protection cover” or a “wind protection board” as an option, wherein
the hanging type seismic isolator is used
by storing the “liquid” in the “container or the excavated hole”, making the “quake-absorbing object structure” float on the “liquid”, hanging the “quake-absorbing object structure” on the “column support for hanging” with the “hanging device”, and fixing the hung “quake-absorbing object structure” with the “fixing device” or releasing the “fixing”, by adjusting the weight of the “quake-absorbing object structure” using the “optional “pouring-draining device”,
by injecting bubbles into the “liquid” stored in the “container or the excavated hole” to make the “liquid” into a liquid mass containing bubbles using the optional “bubble injection device”, and
by protecting the “quake-absorbing object structure” against wind using the optional “wind protection cover” or the “wind protection board”.

23. A transit system executed by the “moving type wired aircraft” described in claim 13, wherein
the “moving type wired aircraft” flies by collecting the electricity from the “stationary type wire” or the “floated type wire”, or by using the “battery” or the optional “electricity generation device” or the optional “internal-combustion engine” loaded on the “moving type wired aircraft”,
the “moving type wired aircraft” delivers a load directly from a shipping source to an address for delivery; or the “moving type wired aircraft” carries a “load” to a relay place of a shipping source from individual shipping source, and after the “load” is collected for each delivery destination in the relay place of the shipping source, the “moving type wired aircraft” carries the collected “load” to a relay place of a delivery destination, and after the collected “load” is personalized in the relay place of the delivery destination, the “moving type wired aircraft” delivers the personalized “load” to the delivery destination.

24. A means of transportation utilizing the “power generation device” using the “power generation method” according to claim 1, selected from a group comprising:
a car driven using the “power generation device”;
a train driven using the “power generation device”;
a ship driven using the “power generation device”, or a barge towed by the ship;
a submarine boat driven using the “power generation device”, or a barge towed by the submarine boat;
an airplane driven using the “power generation device”;
a flying boat driven using the “power generation device” which is able to water-landing under the weakened shock of the water-landing, by injecting bubbles, at the time of water landing, into the water area of water-landing using an injection machine installed in airport or an injection machine with which the flying boat is equipped; and
a snow melting system spraying water heated by passing a pipe equipped with an insulated electrical heater wire, or emitting an air jet through the pipe heated.

25. A car with auxiliary wheels utilizing the “power generation device” using the “power generation method” according to claim 1, comprising
run wheels; the auxiliary wheels the “power generation device”; and a battery, wherein
the run wheels are arranged in series,
the auxiliary wheels are provided on the left and right of the car body for the purpose of safety device against overturning,
the car is driven with a combination of the “power generation device” loaded as an own power generator and the battery, or with a combination of an optional engine, the “power generation device” and the battery,
the car comprises “accelerator device and brake device” characterized by:
the accelerator device being a manual type;
an accelerator operation being done by setting the speed arbitrarily by an manual operation and the car running at the set-up speed;
the brake device being a manual type, or a traditional step type using a brake pedal, or a combined type of the manual type and the step type;
a brake operation being done by the manual type or the step type brake operation; and
the set-up speed being reduced and recovered to the set-up speed and the car body being stopped by the accelerator operation.

26. A hydrofoil train utilizing the “power generation device” using the “power generation method” according to claim 1, comprising:
a waterway; a hydrofoil; a run wheel; and the “power generation device”, wherein
the hydrofoil train runs using the electric power generated by the “power generation device”;
the “waterway” is prepared in a rail track, the “hydrofoil” is inserted in the “waterway”, and a buoyancy is obtained by run; and
the hydrofoil train runs by the “run wheel”.

27. A “power generation device” using the “power generation method” according to claim 1 or an “electric product”, characterized in that:
the “power generation device” is installed in an electric product or used as an in-house power generator and connected to an electric product with a cable; or
the “electric product” is driven by the “power generation device” as the in-house power generator.
